(19) United States
(12) Patent Application Publication
(10) Pub. No.: US 2026/0277126 A1
(43) Pub. Date: Sep. 17, 2026

(54) ELECTROPHOTOGRAPHIC PHOTORECEPTOR, PROCESS CARTRIDGE, IMAGE FORMING APPARATUS, AND FUNCTIONAL LAYER

(71) Applicant: FUJIFILM Business Innovation Corp., Tokyo (JP)

(72) Inventors: Masato Shirakawa, Kanagawa (JP); Tomoya Sasaki, Kanagawa (JP); Ryosuke Fujii, Kanagawa (JP); Masahiro Iwasaki, Kanagawa (JP); Kosuke Narita, Kanagawa (JP)

(73) Assignee: FUJIFILM Business Innovation Corp., Tokyo (JP)

(21) Appl. No.: 19/548,997

(22) Filed: Feb. 25, 2026

(30) Foreign Application Priority Data
Mar. 17, 2025 (JP) 2025-042945

(51) Int. Cl. G03G 5/05; G03G 5/047; G03G 15/08

(52) U.S. Cl. CPC G03G 5/0578; G03G 5/047; G03G 5/0546; G03G 5/0564; G03G 5/0596; G03G 15/0875

(57) ABSTRACT

An electrophotographic photoreceptor includes a conductive substrate and a photosensitive layer disposed on the conductive substrate, in which an outermost surface layer contains a binder resin and silicone rubber particles in which primary particles have a volume-average particle diameter of 0.01 μm or more and less than 3 μm.

### CROSS-REFERENCE TO RELATED APPLICATIONS

This application is based on and claims priority under 35 USC 119 from Japanese Patent Application No. 2025-042945 filed Mar. 17, 2025.

### BACKGROUND

### (i) Technical Field

The present invention relates to an electrophotographic photoreceptor, a process cartridge, an image forming apparatus, and a functional layer.

### (ii) Related Art

JP1993-107783A discloses “electrophotographic photoreceptor including a photosensitive layer or a protective layer in which silicone rubber fine particles are dispersed”.

WO2006/098351A discloses “electrophotographic photoreceptor including a photosensitive layer on a conductive substrate, in which at least an outermost layer thereof contains particles having a double-layer structure including a core material and a shell material having a rubber hardness higher than that of the core material”.

### SUMMARY

An object of the present invention is to provide an electrophotographic photoreceptor having excellent abrasion resistance and crack resistance, as compared with an electrophotographic photoreceptor in which an outermost surface layer thereof contains a binder resin and silicone rubber particles or silicone rubber resin composite particles, each of the particles having a volume-average particle diameter of primary particles of 3.0 μm or more.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

Specific means for achieving the above-described object include the following aspects. Each formula is identical to a formula with the same number described later.

According to an aspect of the present disclosure, there is provided an electrophotographic photoreceptor including a conductive substrate and a photosensitive layer disposed on the conductive substrate,
in which an outermost surface layer contains a binder resin and silicone rubber particles in which primary particles have a volume-average particle diameter of 0.01 μm or more and less than 3 μm.

### BRIEF DESCRIPTION OF THE DRAWINGS

Exemplary embodiment(s) of the present invention will be described in detail based on the following figures, wherein:

FIG. 1 is a partial cross-sectional view showing an example of a layer configuration of an electrophotographic photoreceptor according to the present exemplary embodiment;

FIG. 2 is a partial cross-sectional view showing another example of the layer configuration of the electrophotographic photoreceptor according to the present exemplary embodiment;

FIG. 3 is a partial cross-sectional view showing still another example of the layer configuration of the electrophotographic photoreceptor according to the present exemplary embodiment;

FIG. 4 is a view schematically showing a configuration of an example of an image forming apparatus according to the present exemplary embodiment; and

FIG. 5 is a view schematically showing a configuration of another example of the image forming apparatus according to the present exemplary embodiment.

### DETAILED DESCRIPTION

Hereinafter, exemplary embodiments of the present invention will be described. The following descriptions and examples merely illustrate the exemplary embodiments, and do not limit the scope of the exemplary embodiments.

In the present specification, a numerical range described using “to” represents a range including numerical values listed before and after “to” as the minimum value and the maximum value respectively.

In a numerical range described in a stepwise manner in the present specification, an upper limit value or a lower limit value described in a certain numerical range may be substituted with an upper limit value or a lower limit value in another numerical range described in a stepwise manner. In addition, in the present specification, the upper limit or lower limit of a numerical range may be replaced with values described in Examples.

In the present specification, the term “step” includes not only an independent step but a step that is not clearly distinguished from other steps as long as the purpose of the step is achieved.

In the present specification, in a case where an exemplary embodiment is described with reference to drawings, the configuration of the exemplary embodiment is not limited to the configuration shown in the drawings. In addition, the sizes of members in each drawing are conceptual and do not limit the relative relationship between the sizes of the members.

In the present specification, each component may include a plurality of corresponding substances. In a case where the amount of each component in a composition is mentioned in the present specification, and there are two or more kinds of substances corresponding to each component in the composition, unless otherwise specified, the amount of each component means the total amount of two or more kinds of the substances present in the composition.

In the present specification, each component may include two or more kinds of corresponding particles. In a case where there are two or more kinds of particles corresponding to each component in a composition, unless otherwise specified, the particle size of each component means a value for a mixture of two or more kinds of the particles present in the composition.

In the present specification, unless otherwise specified, an alkyl group and an alkylene group include any of linear, branched, and cyclic groups.

In the present specification, a hydrogen atom in an organic group, an aromatic ring, a linking group, an alkyl group, an alkylene group, an aryl group, an aralkyl group, an alkoxy group, an aryloxy group, and the like may be substituted with a halogen atom.

In the present specification, in a case where a compound is represented by a structural formula, the compound may be represented by a structural formula in which symbols representing a carbon atom and a hydrogen atom (C and H) in a hydrocarbon group and/or a hydrocarbon chain are omitted.

In the present specification, “constitutional unit” of a copolymer or a resin is synonymous with a monomer unit.

### Electrophotographic Photoreceptor

The electrophotographic photoreceptor (hereinafter, also referred to as “photoreceptor”) according to the present exemplary embodiment includes a conductive substrate, and a photosensitive layer disposed on the conductive substrate.

An outermost surface layer of the photoreceptor contains a binder resin and silicone rubber particles in which primary particles have a volume-average particle diameter of 0.01 μm or more and less than 3 μm.

With the above-described configuration, the photoreceptor according to the present exemplary embodiment is a photoreceptor excellent in abrasion resistance and crack resistance. The reason is presumed as follows.

In the related art, for the purpose of improving abrasion resistance of a photoreceptor, it is known to incorporate relatively large silicone rubber particles having a volume-average particle diameter of primary particles of more than 3 μm into an outermost surface layer of the photoreceptor (see, for example, JP1993-107783A). For the same purpose, it is known to incorporate silicone rubber resin composite particles into an outermost surface layer of the photoreceptor (see, for example, WO2006/098351A).

Here, the silicone rubber resin composite particles are particles in which the surface of silicone rubber particles is coated with a silicone resin.

However, recently, it is required to obtain stable quality for a long period of time regardless of the environment. Therefore, further improvement in abrasion resistance of the photoreceptor is required, including improvement in crack resistance (especially at low temperatures).

Accordingly, in the photoreceptor according to the present exemplary embodiment, small-diameter silicone rubber particles in which primary particles have a volume-average particle diameter of 0.01 μm or more and less than 3 μm are contained in the outermost surface layer.

Generally, the silicone rubber particles have a property of easily aggregating, so that aggregated particles of the silicone rubber particles are present in the outermost surface layer of the photoreceptor. In addition, the silicone rubber particles have a larger coefficient of thermal expansion than general binder resins. Therefore, under low-temperature conditions, interfacial stress is generated due to a difference in thermal expansion between the silicone rubber particles and the binder resin, and thus cracks form in the outermost surface layer containing the silicone rubber particles and the binder resin.

By applying the silicone rubber particles having a small primary particle diameter, interface between the silicone rubber particles and the binder resin increases, and thus stress concentration on the interface is alleviated. As a result, crack formation is suppressed regardless of the secondary particle diameter.

On the other hand, the silicone rubber resin composite particles have a property of being difficult to aggregate because a silicone resin is present on the surface, and thus tend to be present as primary particles in the outermost surface layer of the photoreceptor. In contrast, in a case where the silicone rubber particles that are likely to be present as aggregated particles are applied to the outermost surface layer of the photoreceptor, the aggregated particles of the silicone rubber particles collapse upon contact with a cleaning member during cleaning of the photoreceptor (that is, the outermost surface layer). Therefore, compared with a case where the silicone rubber resin composite particles are applied, the coefficient of friction of the outermost surface layer decreases, and thus the abrasion resistance of the photoreceptor is improved.

From the above, it is presumed that the photoreceptor according to the present exemplary embodiment is a photoreceptor excellent in abrasion resistance and crack resistance due to the above-described configuration.

In a case where the silicone rubber particles having a small primary particle diameter are applied, cleaning can be performed without inhibiting the formation of an external additive dam (that is, a stagnant substance formed of an external additive detached from the toner) formed at a contact portion between the cleaning member and the photoreceptor during cleaning, so that the photoreceptor according to the present exemplary embodiment is also excellent in cleanability of the outermost surface layer.

In a case where the silicone rubber particles having a small primary particle diameter are applied, a phenomenon occurs in which aggregated particles of the silicone rubber particles collapse upon contact with the cleaning member during cleaning of the surface layer, so that the photoreceptor according to the present exemplary embodiment is also excellent in lubricity of the outermost surface layer.

Hereinafter, the photoreceptor according to the present exemplary embodiment will be described in detail.

Examples of a layer configuration of the photoreceptor according to the present exemplary embodiment include the following aspects.
(1) A first aspect in which an undercoat layer, and a charge generation layer and a charge transport layer as the photosensitive layer are provided in this order on the conductive substrate, and the outermost surface layer is the charge transport layer.
(2) A second aspect in which an undercoat layer and a single layer-type photosensitive layer as the photosensitive layer are provided in this order on the conductive substrate, and the outermost surface layer is the single layer-type photosensitive layer.
(3) A third aspect in which an undercoat layer, a charge generation layer and a charge transport layer as the photosensitive layer, and a protective layer are provided in this order on the conductive substrate, and the outermost surface layer is the protective layer.

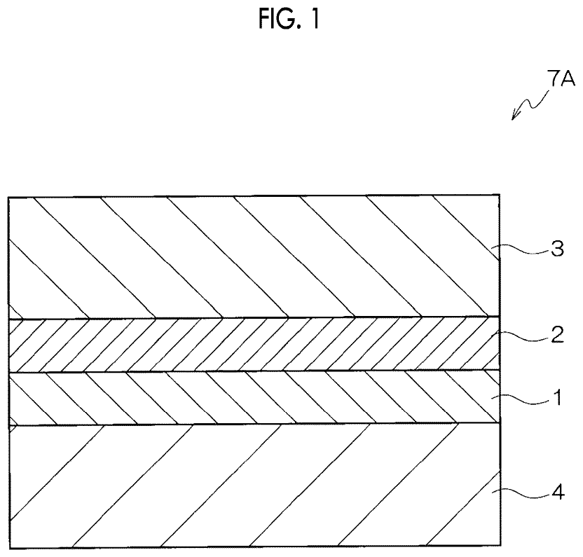

Specifically, as shown in FIG. 1, a photoreceptor 7A of the first aspect is a so-called function-separated type photoreceptor (or laminated type photoreceptor), and has a structure in which an undercoat layer 1 is provided on a conductive substrate 4, and a charge generation layer 2 and a charge transport layer 3 are sequentially formed thereon. In the photoreceptor 7A of the first aspect, the photosensitive layer is constituted by the charge generation layer 2 and the charge transport layer 3.

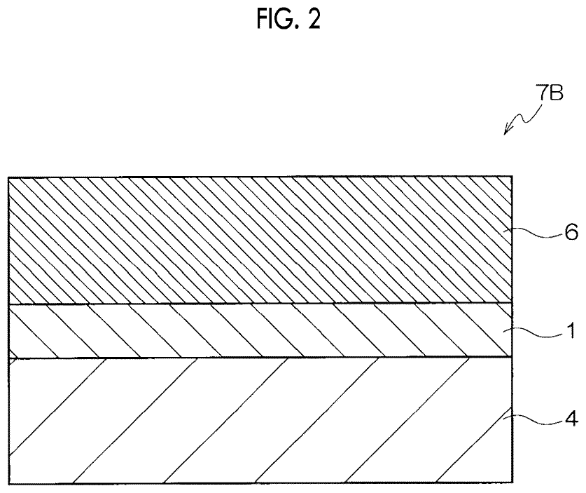

In addition, as shown in FIG. 2, a photoreceptor 7B of the second aspect has a structure in which an undercoat layer 1 is provided on a conductive substrate 4, and a single layer-type photosensitive layer 6 is formed thereon. That is, the photoreceptor 7B of the second aspect contains a charge generation material and a charge transport material in the same single layer-type photosensitive layer 6.

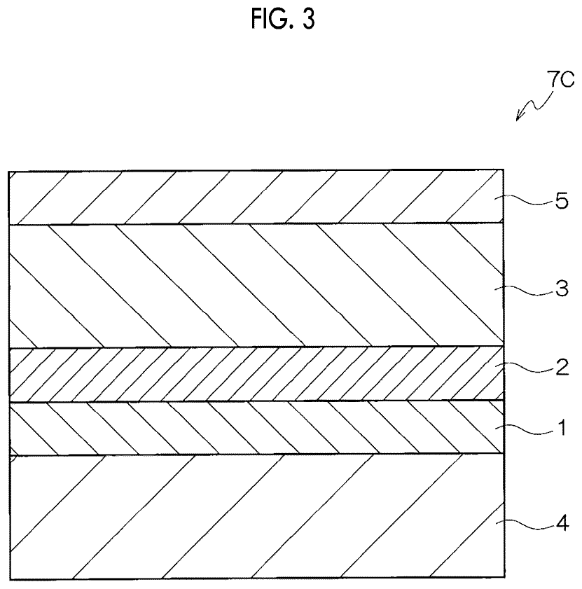

Furthermore, as shown in FIG. 3, a photoreceptor 7C of the third aspect is a photoreceptor in which a protective layer 5 is provided on the photoreceptor 7A of the first aspect. That is, the photoreceptor 7C of the third aspect has a structure in which an undercoat layer 1 is provided on a conductive substrate 4, and a charge generation layer 2, a charge transport layer 3, and a protective layer 5 are sequentially formed thereon.

In the photoreceptor 7A of the first aspect shown in FIG. 1, the charge transport layer 3 serves as the outermost surface layer disposed on a side farthest from the conductive substrate 4, and the outermost surface layer is configured to satisfy the above-described requirements.

In the photoreceptor 7B of the second aspect shown in FIG. 2, the single layer-type photosensitive layer 6 serves as the outermost surface layer disposed on a side farthest from the conductive substrate 4, and the outermost surface layer is configured to satisfy the above-described requirements.

In the photoreceptor 7C of the third aspect shown in FIG. 3, the protective layer 5 serves as the outermost surface layer disposed on a side farthest from the conductive substrate 4, and the outermost surface layer is configured to satisfy the above-described requirements.

In the photoreceptors 7A to 7C of the first to third aspects shown in FIGS. 1 to 3, the undercoat layer 1 may or may not be provided.

Next, details of the configuration of the outermost surface layer of the photoreceptor will be described. Hereinafter, the reference numerals will be omitted in the description.

### Outermost Surface Layer

The outermost surface layer contains a binder resin and silicone rubber particles.

A formulation of the outermost surface layer is selected according to the corresponding layer.

Specifically, in a case where the outermost surface layer corresponds to the charge transport layer, for example, the formulation includes a charge transport material in addition to the binder resin and the silicone rubber particles.

In addition, in a case where the outermost surface layer corresponds to the charge transport layer, for example, the formulation employs, as the binder resin, a cured product of a charge-transporting material having a polymerizable functional group.

Furthermore, in a case where the outermost surface layer corresponds to the single layer-type photosensitive layer, for example, the formulation includes a charge generation material and a charge transport material, in addition to the binder resin and the silicone rubber particles.

### Silicone Rubber Particles

As the silicone rubber particles, silicone rubber particles in which primary particles have a volume-average particle diameter of 0.01 μm or more and less than 3 μm are applied.

In a case where the volume-average particle diameter of the primary particles in the silicone rubber particles is less than 0.01 m, the cleanability deteriorates. This is because secondary particles formed by aggregation of the primary particles of the silicone rubber particles have an increased surface area, thereby increasing the contact area with the binder resin and improving adhesion. As a result, the adhesion between the silicone rubber particles and the binder resin is to be strong against a contact pressure of the cleaning member acting per unit volume, and the aggregates become difficult to collapse. For this reason, the friction coefficient fails to decrease, resulting in a high friction force being generated between the cleaning member and the outermost surface layer; the cleaning member vibrates, thereby forming a gap between the cleaning member and the outermost surface layer, and consequently the cleanability is degraded.

In a case where the volume-average particle diameter of the primary particles in the silicone rubber particles is 3 μm or more, crack resistance and cleanability deteriorate.

The reason why crack resistance deteriorates is that, in a case where the primary particle diameter is 3 μm or more, the contact interface between the silicone rubber particles and the binder resin is small, and stress concentration on the interface is not sufficiently alleviated. Therefore, it is considered that the crack resistance deteriorates.

The reason why cleanability deteriorates is considered to be that, in a case where the primary particle diameter is 3 μm or more, the diameter approaches the particle diameter of toner particles, thereby inhibiting the formation of an external additive dam that contributes to cleanability.

Accordingly, the volume-average particle diameter of the primary particles in the silicone rubber particles is set within the above-described range.

The volume-average particle diameter of the primary particles in the silicone rubber particles is, for example, preferably 0.05 μm or more and 2 μm or less, more preferably 0.1 μm or more and 1 μm or less, and most preferably 0.2 μm or more and 0.5 μm or less.

In a case where the volume-average particle diameter of the primary particles in the silicone rubber particles is as small as the above-described range, the silicone rubber particles tend to be present as aggregated particles in the outermost surface layer. Therefore, it is considered that a phenomenon occurs in which the aggregated particles of the silicone rubber particles collapse upon contact with the cleaning member during cleaning of the photoreceptor (that is, the outermost surface layer thereof). As a result, the friction coefficient of the outermost surface layer decreases, and the abrasion resistance of the photoreceptor improves.

A volume-average particle diameter of secondary particles (that is, aggregated particles) of the silicone rubber particles is, for example, preferably less than 30 μm.

In a case where the volume-average particle diameter of the secondary particles in the silicone rubber particles is less than 30 m, the cleanability is likely to improve. This is considered to be because slipping of toner particles through the cleaning member due to excessively large secondary particles can be suppressed.

Therefore, the volume-average particle diameter of the secondary particles in the silicone rubber particles is set within the above-described range.

The volume-average particle diameter of the secondary particles in the silicone rubber particles is, for example, preferably 20 μm or less, more preferably 15 μm or less, and most preferably 10 μm or less. There is no particular lower limit for the secondary particles.

Regarding the silicone rubber particles, although the cleanability deteriorates in a case where the primary particle diameter is 3 μm or more, the cleanability is not impaired even in a case where the secondary particle diameter is 3 μm or more, because the secondary particles are rapidly collapsed by the cleaning member to be primary particles of less than 3 am. Accordingly, it is considered that formation of the external additive dam is not inhibited.

The volume-average particle diameter of the primary particles in the silicone rubber particles can be adjusted by, for example, a method of controlling during synthesis, a method of crushing commercial powder, or a method of classifying commercial or synthetic emulsions.

Examples of the classification method include sieving with a mesh filter, a sedimentation method, and a centrifugation method.

A method of measuring the volume-average particle diameter of the primary particles and the secondary particles (that is, the aggregated particles) in the silicone rubber particles is as follows.

First, a sample cut along a film thickness direction of the outermost surface layer to be measured is obtained.

A cross section of the sample is observed with a scanning electron microscope (SEM) apparatus (manufactured by Hitachi, Ltd.: S-4100) to capture an image.

The obtained image is taken into an image analysis device (LUZEX III, manufactured by Nireco Corporation), the area of each primary particle or secondary particle (that is, aggregated particle) is measured by image analysis of silica particles, and an equivalent circle diameter is calculated from the area value. Calculation of the equivalent circle diameter is performed for 100 silicone rubber particles. A 50% diameter (D50v) in the volume-based cumulative frequency of the obtained equivalent circle diameters is defined as the volume-average particle diameter of the primary particles or the secondary particles (that is, the aggregated particles) in the silicone rubber particles.

The magnification of the electron microscope is adjusted so that approximately 10 to 50 primary particles or secondary particles (that is, aggregated particles) of the silicone rubber particles appear in one field of view, and the equivalent circle diameter of the silicone rubber particles is determined by combining observations of a plurality of fields of view.

In addition, in the sea-island structure observed in the captured image, the sea portion may be identified as the binder resin and the island portion as the silicone rubber particles. In a case of being difficult to identify, the contrast may be adjusted, for example, by changing the accelerating voltage during measurement so that the sea-island structure can be identified.

As the silicone rubber particles, particles having a single-layer structure composed of silicone rubber are applied.

Examples of the silicone rubber particles include crosslinked particles obtained by crosslinking polyorganosiloxane (linear polydimethylsiloxane, polymethylphenylsiloxane, polydiphenylsiloxane, and the like).

As the silicone rubber particles, synthetic products, classified products of commercial products, crushed products of commercial products, and the like can be applied.

Examples of commercial silicone rubber particles include KMP-9729, KMP-402, KMP-597, KMP-598, and X-52-1133 manufactured by Shin-Etsu Chemical Co., Ltd.

A content of the silicone rubber particles is, for example, preferably 0.5% by mass or more and 25% by mass or less, more preferably 1% by mass or more and 20% by mass or less, still more preferably 2% by mass or more and 17% by mass or less, and most preferably 3% by mass or more and 15% by mass or less with respect to the outermost surface layer.

In a case where the content of the silicone rubber particles is within the above-described range, the abrasion resistance and the crack resistance are likely to improve. In addition, the cleanability, the crack resistance, and the lubricity of the outermost surface layer are also likely to improve.

### Binder Resin

As the binder resin, for example, at least one of a polyarylate resin or a polycarbonate resin is preferable from the viewpoint of improving the abrasion resistance.

As the binder resin, for example, a polymer or a crosslinked body of a reactive group-containing charge transport material having a reactive group and a charge-transporting skeleton in the identical molecule is also suitable from the viewpoint of improving the abrasion resistance.

Details of the binder resin will be described later, but it is preferable to select the binder resin depending on whether the outermost surface layer corresponds to, for example, the charge transport layer, the single layer-type photosensitive layer, or the protective layer.

Hereinafter, each layer of the electrophotographic photoreceptor according to the present exemplary embodiment will be described in detail.

### Conductive Substrate

Examples of the conductive substrate include metal plates, metal drums, metal belts, or the like, containing a metal (such as aluminum, copper, zinc, chromium, nickel, molybdenum, vanadium, indium, gold, and platinum) or an alloy (such as stainless steel). In addition, examples of the conductive substrate also include paper, a resin film, a belt, or the like, that is obtained by being coated, vapor-deposited, or laminated with a conductive compound (such as a conductive polymer and indium oxide), a metal (such as aluminum, palladium, and gold) or an alloy. Here, the term “conductive” denotes that a volume resistivity is less than 10¹³ Ω·cm.

In a case where the electrophotographic photoreceptor is used in a laser printer, for example, it is preferable that a surface of the conductive substrate is roughened such that a centerline average roughness Ra thereof is 0.04 μm or more and 0.5 μm or less for the purpose of suppressing interference fringes from occurring in a case of irradiation with laser beams. In a case where incoherent light is used as a light source, roughening of the surface to prevent the interference fringes is not particularly necessary, and it is appropriate for longer life because occurrence of defects due to the roughness of the surface of the conductive substrate is suppressed.

Examples of the roughening method include wet honing performed by suspending an abrasive in water and spraying the suspension to the conductive substrate, centerless grinding performed by pressure-welding the conductive substrate against a rotating grindstone and continuously grinding the conductive substrate, and an anodizing treatment.

Examples of the roughening method also include a method of dispersing conductive or semi-conductive powder in a resin without roughening the surface of the conductive substrate to form a layer on the surface of the conductive substrate, and performing roughening using the particles dispersed in the layer.

The roughening treatment by anodization is a treatment of forming an oxide film on the surface of the conductive substrate by carrying out anodization in an electrolytic solution using a conductive substrate made of a metal (for example, aluminum) as an anode. Examples of the electrolytic solution include a sulfuric acid solution and an oxalic acid solution. However, a porous anodized film formed by the anodization is chemically active in a natural state, is easily contaminated, and has a large resistance fluctuation depending on the environment. Therefore, for example, it is preferable that a sealing treatment is performed on the porous anodized film so that micropores of the oxide film are closed by volume expansion due to a hydration reaction in pressurized steam or boiling water (a metal salt such as nickel may be added thereto) for a change into a more stable hydrous oxide.

A film thickness of the anodized film is, for example, preferably 0.3 μm or more and m or less. In a case where the film thickness is in the above-described range, the barrier properties against injection tend to be exhibited, and an increase in the residual potential due to repeated use tends to be suppressed.

The conductive substrate may be subjected to a treatment with an acidic treatment liquid or a boehmite treatment.

The treatment with an acidic treatment liquid is carried out, for example, as follows. First, an acidic treatment liquid containing phosphoric acid, chromic acid, and hydrofluoric acid is prepared. As a blending proportion of the phosphoric acid, chromic acid, and hydrofluoric acid to the acidic treatment liquid, for example, a concentration of the phosphoric acid may be in a range of 10% by mass or more and 11% by mass or less, a concentration of the chromic acid may be in a range of 3% by mass or more and 5% by mass or less, and a concentration of the hydrofluoric acid may be in a range of 0.5% by mass or more and 2% by mass or less, and a concentration of all of these acids may be in a range of 13.5% by mass or more and 18% by mass or less. A treatment temperature is, for example, preferably 42° C. or higher and 48° C. or lower. A film thickness of the coating film is, for example, preferably 0.3 μm or more and 15 m or less.

The boehmite treatment is carried out, for example, by dipping the base material in pure water at 90° C. or higher and 100° C. or lower for 5 minutes to 60 minutes, or by bringing the base material into contact with heated steam at 90° C. or higher and 120° C. or lower for 5 minutes to 60 minutes. A film thickness of the coating film is, for example, preferably 0.1 μm or more and m or less. The coating film may be further subjected to the anodizing treatment using an electrolytic solution having low film solubility, such as adipic acid, boric acid, a borate, a phosphate, a phthalate, a maleate, a benzoate, a tartrate, or a citrate.

### Undercoat Layer

The undercoat layer is, for example, a layer containing inorganic particles and a binder resin.

Examples of the inorganic particles include inorganic particles having a powder resistance (volume resistivity) of 10² Ω·cm or more and 10¹¹ Ω·cm or less.

Among the above, as the inorganic particles having the above-described resistance value, for example, metal oxide particles such as tin oxide particles, titanium oxide particles, zinc oxide particles, and zirconium oxide particles may be used, and zinc oxide particles are particularly preferable.

A specific surface area of the inorganic particles, measured by a BET method, may be, for example, 10 m²/g or more.

A volume-average particle diameter of the inorganic particles may be, for example, 50 nm or more and 2,000 nm or less (for example, preferably 60 nm or more and 1,000 nm or less).

A content of the inorganic particles is, for example, preferably 10% by mass or more and 80% by mass or less and more preferably 40% by mass or more and 80% by mass or less with respect to the amount of the binder resin.

The inorganic particles may be subjected to a surface treatment. As the inorganic particles, inorganic particles subjected to different surface treatments or inorganic particles having different particle diameters may be used in the form of a mixture of two or more kinds thereof.

Examples of the surface treatment agent include a silane coupling agent, a titanate-based coupling agent, an aluminum-based coupling agent, and a surfactant. In particular, for example, a silane coupling agent is preferable, and a silane coupling agent containing an amino group is more preferable.

Examples of the silane coupling agent containing an amino group include 3-aminopropyltriethoxysilane, N-2-(aminoethyl)-3-aminopropyltrimethoxysilane, N-2-(aminoethyl)-3-aminopropylmethyldimethoxysilane, and N,N-bis(2-hydroxyethyl)-3-aminopropyltriethoxysilane, but are not limited thereto.

The silane coupling agent may be used in the form of a mixture of two or more kinds thereof. For example, the silane coupling agent having an amino group and other silane coupling agents may be used in combination. Examples of other silane coupling agents include vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane, but are not limited thereto.

The surface treatment method using a surface treatment agent may be any method as long as the method is a known method, and any of a dry method or a wet method may be used.

A treatment amount of the surface treatment agent is, for example, preferably 0.5% by mass or more and 10% by mass or less with respect to the inorganic particles.

Here, the undercoat layer may contain an electron-accepting compound (acceptor compound) together with the inorganic particles from the viewpoint of enhancing long-term stability of electrical properties and carrier blocking properties.

Examples of the electron-accepting compound include electron-transporting substances such as a compound having an anthraquinone structure; a quinone-based compound such as chloranil and bromanil; a tetracyanoquinodimethane-based compound; a fluorenone compound such as 2,4,7-trinitrofluorenone and 2,4,5,7-tetranitro-9-fluorenone; an oxadiazole-based compound such as 2-(4-biphenyl)-5-(4-t-butylphenyl)-1,3,4-oxadiazole, 2,5-bis(4-naphthyl)-1,3,4-oxadiazole, and 2,5-bis(4-diethylaminophenyl)-1,3,4-oxadiazole; a xanthone-based compound; a thiophene compound; a diphenoquinone compound such as 3,3′,5,5′-tetra-t-butyldiphenoquinone; and a benzophenone compound.

In particular, as the electron-accepting compound, for example, a compound having an anthraquinone structure is preferable. As the compound having an anthraquinone structure, for example, a hydroxyanthraquinone compound, an aminoanthraquinone compound, or an aminohydroxyanthraquinone compound is preferable; and specifically, anthraquinone, alizarin, quinizarin, anthrarufin, purpurin, 4-ethoxy-1,2-dihydroxy-9,10-anthraquinone (EDHA), or a derivative thereof is preferable.

The electron-accepting compound may be contained in the undercoat layer in a state of being dispersed with inorganic particles or in a state of being attached to the surface of each inorganic particle.

Examples of the method of attaching the electron-accepting compound to the surface of the inorganic particle include a dry method and a wet method.

The dry method is, for example, a method of attaching the electron-accepting compound to the surface of the inorganic particles by adding the electron-accepting compound dropwise to the inorganic particles directly or by dissolving the electron-accepting compound in an organic solvent while stirring the inorganic particles with a mixer having a large shearing force and spraying the mixture together with dry air or nitrogen gas. For example, the dropwise addition or spraying of the electron-accepting compound may be performed at a temperature equal to or lower than a boiling point of the solvent. After the dropwise addition or spraying of the electron-accepting compound, the mixture may be further baked at 100° C. or higher. The baking is not particularly limited as long as the temperature and the time are adjusted such that the electrophotographic characteristics can be obtained.

The wet method is, for example, a method of attaching the electron-accepting compound to the surface of the inorganic particles by adding the electron-accepting compound to inorganic particles while dispersing the inorganic particles in a solvent using a stirrer, an ultrasonic disperser, a sand mill, an attritor, or a ball mill, stirring or dispersing the mixture, and removing the solvent. The solvent removing method is carried out by, for example, filtration or distillation so that the solvent is distilled off. After removal of the solvent, the mixture may be further baked at 100° C. or higher. The baking is not particularly limited as long as the temperature and the time are adjusted such that electrophotographic characteristics can be obtained. In the wet method, the moisture contained in the inorganic particles may be removed before the electron-accepting compound is added, and examples thereof include a method of removing the moisture while stirring and heating the moisture in a solvent and a method of removing the moisture by azeotropically boiling the moisture with a solvent.

The electron-accepting compound may be attached before or after the inorganic particles are subjected to the surface treatment with the surface treatment agent or simultaneously with the surface treatment with the surface treatment agent.

A content of the electron-accepting compound may be, for example, 0.01% by mass or more and 20% by mass or less and is preferably 0.01% by mass or more and 10% by mass or less with respect to the amount of the inorganic particles.

Examples of the binder resin used for the undercoat layer include a known polymer compound such as an acetal resin (such as polyvinyl butyral), a polyvinyl alcohol resin, a polyvinyl acetal resin, a casein resin, a polyamide resin, a cellulose resin, gelatin, a polyurethane resin, a polyester resin, an unsaturated polyester resin, a methacrylic resin, an acrylic resin, a polyvinyl chloride resin, a polyvinyl acetate resin, a vinyl chloride-vinyl acetate-maleic anhydride resin, a silicone resin, a silicone-alkyd resin, a urea resin, a phenol resin, a phenol-formaldehyde resin, a melamine resin, a urethane resin, an alkyd resin, and an epoxy resin; a zirconium chelate compound; a titanium chelate compound; an aluminum chelate compound; a titanium alkoxide compound; an organic titanium compound; and a known material such as a silane coupling agent.

Examples of the binder resin used for the undercoat layer include a charge-transporting resin containing a charge-transporting group, and a conductive resin (such as polyaniline).

Among the above, as the binder resin used for the undercoat layer, for example, a resin insoluble in a coating solvent of the upper layer is preferable, and a resin obtained by the reaction between a curing agent and at least one resin selected from the group consisting of a thermosetting resin such as a urea resin, a phenol resin, a phenol-formaldehyde resin, a melamine resin, a urethane resin, an unsaturated polyester resin, an alkyd resin, or an epoxy resin; a polyamide resin, a polyester resin, a polyether resin, a methacrylic resin, an acrylic resin, a polyvinyl alcohol resin, and a polyvinyl acetal resin is particularly preferable.

In a case where these binder resins are used in combination of two or more kinds thereof, the mixing ratio thereof is set as necessary.

The undercoat layer may contain various additives for improving the electrical properties, the environmental stability, and the image quality.

Examples of the additive include known materials, for example, an electron-transporting pigment such as a polycyclic condensed pigment or an azo-based pigment, a zirconium chelate compound, a titanium chelate compound, an aluminum chelate compound, a titanium alkoxide compound, an organic titanium compound, and a silane coupling agent. The silane coupling agent is used for a surface treatment of the inorganic particles as described above, but may be further added to the undercoat layer as an additive.

Examples of the silane coupling agent as the additive include vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane.

Examples of the zirconium chelate compound include zirconium butoxide, ethyl zirconium acetoacetate, zirconium triethanolamine, acetylacetonate zirconium butoxide, ethyl zirconium butoxide acetoacetate, zirconium acetate, zirconium oxalate, zirconium lactate, zirconium phosphonate, zirconium octanoate, zirconium naphthenate, zirconium laurate, zirconium stearate, zirconium isostearate, zirconium butoxide methacrylate, stearate zirconium butoxide, and isostearate zirconium butoxide.

Examples of the titanium chelate compound include tetraisopropyl titanate, tetranormal butyl titanate, a butyl titanate dimer, tetra(2-ethylhexyl) titanate, titanium acetylacetonate, polytitanium acetylacetonate, titanium octylene glycolate, titanium lactate ammonium salt, titanium lactate, titanium lactate ethyl ester, titanium triethanol aminate, and polyhydroxy titanium stearate.

Examples of the aluminum chelate compound include aluminum isopropylate, monobutoxyaluminum diisopropylate, aluminum butyrate, diethylacetoacetate aluminum diisopropylate, and aluminum tris(ethylacetoacetate).

These additives may be used alone or in a form of a mixture or a polycondensate of a plurality of compounds.

The undercoat layer may have, for example, a Vickers hardness of 35 or more.

For example, the surface roughness (ten-point average roughness) of the undercoat layer may be adjusted to ½ from 1/(4n) (n represents a refractive index of an upper layer) of a laser wavelength λ for exposure to be used to suppress moire fringes.

Resin particles or the like may be added to the undercoat layer to adjust the surface roughness. Examples of the resin particles include silicone resin particles and crosslinked polymethyl methacrylate resin particles. In addition, the surface of the undercoat layer may be polished to adjust the surface roughness. Examples of the polishing method include buff polishing, a sandblast treatment, wet honing, and a grinding treatment.

The formation of the undercoat layer is not particularly limited, and a known forming method in the related art is used. For example, a coating film of a coating solution for forming the undercoat layer, in which the above-described components are added to a solvent, is formed, and the coating film is dried and then heated as necessary.

Examples of the solvent for preparing the coating solution for forming an undercoat layer include known organic solvents such as an alcohol-based solvent, an aromatic hydrocarbon solvent, a halogenated hydrocarbon solvent, a ketone-based solvent, a ketone alcohol-based solvent, an ether-based solvent, and an ester-based solvent.

Specific examples of the solvent include typical organic solvents such as methanol, ethanol, n-propanol, iso-propanol, n-butanol, benzyl alcohol, methyl cellosolve, ethyl cellosolve, acetone, methyl ethyl ketone, cyclohexanone, methyl acetate, ethyl acetate, n-butyl acetate, dioxane, tetrahydrofuran, methylene chloride, chloroform, chlorobenzene, and toluene.

Examples of the method of dispersing the inorganic particles in a case of preparing the coating solution for forming an undercoat layer include known methods such as a roll mill, a ball mill, a vibration ball mill, an attritor, a sand mill, a colloid mill, and a paint shaker.

Examples of the method of coating the conductive substrate with the coating solution for forming an undercoat layer include typical coating methods such as a blade coating method, a wire bar coating method, a spray coating method, a dip coating method, a bead coating method, an air knife coating method, and a curtain coating method.

A film thickness of the undercoat layer is set to, for example, preferably 15 μm or more and more preferably in a range of 20 μm or more and 50 μm or less.

### Interlayer

Although not shown in the drawings, an interlayer may be further provided between the undercoat layer and the photosensitive layer.

The interlayer is, for example, a layer containing a resin. Examples of the resin used for the interlayer include polymer compounds such as an acetal resin (for example, polyvinyl butyral or the like), a polyvinyl alcohol resin, a polyvinyl acetal resin, a casein resin, a polyamide resin, a cellulose resin, gelatin, a polyurethane resin, a polyester resin, a methacrylic resin, an acrylic resin, a polyvinyl chloride resin, a polyvinyl acetate resin, a vinyl chloride-vinyl acetate-maleic anhydride resin, a silicone resin, a silicone-alkyd resin, a phenol-formaldehyde resin, and a melamine resin.

The interlayer may be a layer containing an organometallic compound. Examples of the organometallic compound used for the interlayer include organometallic compounds containing a metal atom such as zirconium, titanium, aluminum, manganese, and silicon.

The compounds used for the interlayer may be used alone or in the form of a mixture or a polycondensate of a plurality of compounds.

Among the above, for example, it is preferable that the interlayer is a layer containing an organometallic compound containing a zirconium atom or a silicon atom.

The formation of the interlayer is not particularly limited, and a known forming method in the related art is used. For example, a coating film of a coating solution for forming the interlayer, in which the above-described components are added to a solvent, is formed, and the coating film is dried and then heated as necessary.

Examples of the coating method of forming the interlayer include typical methods such as a dip coating method, a push-up coating method, a wire bar coating method, a spray coating method, a blade coating method, an air knife coating method, and a curtain coating method.

A film thickness of the interlayer is set to, for example, preferably in a range of 0.1 μm or more and 3 μm or less. The interlayer may be used as the undercoat layer.

### Charge Generation Layer

A charge generation layer is, for example, a layer containing a charge generation material and a binder resin. In addition, the charge generation layer may be a deposition layer of the charge generation material. For example, the deposition layer of the charge generation material is preferable in a case where an incoherent light source such as a light emitting diode (LED) and an organic electro-luminescence (EL) image array is used.

Examples of the charge generation material include an azo pigment such as bisazo or trisazo; a fused ring aromatic pigment such as dibromoanthanthrone; a perylene pigment; a pyrrolopyrrole pigment; a phthalocyanine pigment; zinc oxide; and trigonal selenium.

Among the above, for example, a metal phthalocyanine pigment or a metal-free phthalocyanine pigment is preferably used as the charge generation material, in order to deal with laser exposure in a near-infrared region. Specifically, for example, hydroxygallium phthalocyanine, chlorogallium phthalocyanine, dichloro-tin phthalocyanine, and titanyl phthalocyanine are more preferable.

On the other hand, for example, a fused ring aromatic pigment such as dibromoanthanthrone, a thioindigo-based pigment, a porphyrazine compound, zinc oxide, trigonal selenium, or a bisazo pigment is preferable as the charge generation material in order to deal with laser exposure in a near ultraviolet region.

The above-described charge generation material may be used even in a case where an incoherent light source such as an LED having a central wavelength of light emission in a range of 450 nm or more and 780 nm or less and an organic EL image array is used.

In a case where an n-type semiconductor such as a fused ring aromatic pigment, a perylene pigment, and an azo pigment is used as the charge generation material, a dark current is unlikely to be generated, and image defects referred to as black spots can be suppressed even in a case in which a thin film is used.

The n-type is determined by the polarity of the flowing photocurrent using a typically used time-of-flight method, and a material in which electrons more easily flow as carriers than positive holes is determined as the n-type.

The binder resin used for the charge generation layer is selected from a wide range of insulating resins, and the binder resin may be selected from organic photoconductive polymers such as poly-N-vinylcarbazole, polyvinylanthracene, polyvinylpyrene, and polysilane.

Examples of the binder resin include a polyvinyl butyral resin, a polyarylate resin (polycondensate of bisphenols and aromatic divalent carboxylic acid, or the like), a polycarbonate resin, a polyester resin, a phenoxy resin, a vinyl chloride-vinyl acetate copolymer, a polyamide resin, an acrylic resin, a polyacrylamide resin, a polyvinylpyridine resin, a cellulose resin, a urethane resin, an epoxy resin, casein, a polyvinyl alcohol resin, and a polyvinylpyrrolidone resin. Here, “insulating” means that a volume resistivity is 10¹³ Ω·cm or more.

These binder resins are used alone or in the form of a mixture of two or more kinds thereof.

A blending ratio between the charge generation material and the binder resin is, for example, preferably in a range of 10:1 to 1:10 in terms of mass ratio.

The charge generation layer may also contain other known additives.

The formation of the charge generation layer is not particularly limited, and a known forming method in the related art is used. For example, a coating film of a coating solution for forming the charge generation layer, in which the above-described components are added to a solvent, is formed, and the coating film is dried and then heated as necessary. The charge generation layer may be formed by a vapor deposition of the charge generation material. For example, the formation of the charge generation layer by the vapor deposition is particularly preferable in a case where the fused ring aromatic pigment or the perylene pigment is used as the charge generation material.

Examples of the solvent for preparing the coating solution for forming the charge generation layer include methanol, ethanol, n-propanol, n-butanol, benzyl alcohol, methyl cellosolve, ethyl cellosolve, acetone, methyl ethyl ketone, cyclohexanone, methyl acetate, n-butyl acetate, dioxane, tetrahydrofuran, methylene chloride, chloroform, chlorobenzene, and toluene. The solvents are used alone or in a form of a mixture of two or more kinds thereof.

As a method of dispersing particles (for example, the charge generation material) in the coating solution for forming the charge generation layer, for example, a media disperser such as a ball mill, a vibration ball mill, an attritor, a sand mill, and a horizontal sand mill, or a medialess disperser such as a stirrer, an ultrasonic disperser, a roll mill, and a high-pressure homogenizer is used. Examples of the high-pressure homogenizer include a collision type high-pressure homogenizer in which a dispersion liquid is dispersed by a liquid-liquid collision or a liquid-wall collision in a high-pressure state, and a penetration type high-pressure homogenizer in which a dispersion liquid is dispersed by causing the dispersion liquid to penetrate through a micro-flow path in a high-pressure state.

During the dispersion, it is effective to set an average particle diameter of the charge generation material in the coating solution for forming the charge generation layer to 0.5 μm or less, for example, preferably 0.3 μm or less and more preferably 0.15 μm or less.

Examples of the method of coating the undercoat layer (or the interlayer) with the coating solution for forming the charge generation layer include typical methods such as a blade coating method, a wire bar coating method, a spray coating method, a dip coating method, a bead coating method, an air knife coating method, and a curtain coating method.

A film thickness of the charge generation layer is set to, for example, preferably in a range of 0.1 μm or more and 5.0 μm or less and more preferably in a range of 0.2 μm or more and 2.0 μm or less.

### Charge Transport Layer

A charge transport layer is, for example, a layer containing a charge transport material and a binder resin. The charge transport layer may be a layer containing a polymer charge transport material.

In a case where the charge transport layer corresponds to the outermost surface layer, the charge transport layer also contains the above-described silicone rubber particles.

### Charge Transport Material

Examples of the charge transport material include a quinone-based compound such as p-benzoquinone, chloranil, bromanil, or anthraquinone; a tetracyanoquinodimethane-based compound; a fluorenone compound such as 2,4,7-trinitrofluorenone; a xanthone compound; a benzophenone-based compound; a cyanovinyl-based compound; and an electron-transporting compound such as an ethylene-based compound. Examples of the charge transport material also include a positive hole-transporting compound such as a triarylamine-based compound, a benzidine-based compound, an arylalkane-based compound, an aryl-substituted ethylene-based compound, a stilbene-based compound, an anthracene-based compound, and a hydrazone-based compound. The charge transport materials may be used alone or in combination of two or more kinds thereof, but are not limited thereto.

Examples of the polymer charge transport material include known chemical substances having charge transport properties, such as poly-N-vinylcarbazole and polysilane. For example, a polyester-based polymer charge transport material is preferable. The polymer charge transport material may be used alone or in combination with a binder resin.

Examples of the charge transport material or the polymer charge transport material include a polycyclic aromatic compound, an aromatic nitro compound, an aromatic amine compound, a heterocyclic compound, a hydrazone compound, a styryl compound, an enamine compound, a benzidine compound, a triarylamine compound (particularly, a triphenylamine compound), a diamine compound, an oxadiazole compound, a carbazole compound, an organic polysilane compound, a pyrazoline compound, an indole compound, an oxazole compound, an isoxazole compound, a thiazole compound, a thiadiazole compound, an imidazole compound, a pyrazole compound, a triazole compound, a cyano compound, a benzofuran compound, an aniline compound, a butadiene compound, and a resin containing a group derived from these substances. Specific examples thereof include compounds described in paragraphs 0078 to 0080 of JP2021-117377A, paragraphs 0046 to 0048 of JP2019-035900A, paragraphs 0052 and 0053 of JP2019-012141A, paragraphs 0122 to 0134 of JP2021-071565A, paragraphs 0101 to 0110 of JP2021-015223A, paragraph 0116 of JP2013-097300A, paragraphs 0309 to 0316 of WO2019/070003A, paragraphs 0103 to 0107 of JP2018-159087A, and paragraphs 0102 to 0113 of JP2021-148818A.

From the viewpoint of the charge mobility, for example, it is preferable that the charge transport material contains at least one selected from the group consisting of a chemical substance (C1) represented by Formula (C1), a chemical substance (C2) represented by Formula (C2), a chemical substance (C3) represented by Formula (C3), and a chemical substance (C4) represented by Formula (C4).

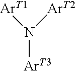

In Formula (C1), Ar^{T1}, Ar^{T2}, and Ar^{T3} are each independently an aryl group, —C₆H₄—C(R^{T4})═C(R^{T5})(R^{T6}), or —C₆H₄—CH═CH—CH═C(R^{T7})(R^{T8}). R^{T4}, R^{T5}, R^{T6}, R^{T7}, and R^{T8} are each independently a hydrogen atom, an alkyl group, or an aryl group. In a case where R^{T5} and R^{T6} are aryl groups, the aryl groups may be linked through a divalent group of —C(R⁵¹)(R⁵²)— and/or —C(R⁶¹)═C(R⁶²)—. R⁵¹, R⁵², R⁶¹, and R⁶² are each independently a hydrogen atom or an alkyl group having 1 or more and 3 or less carbon atoms.

The group in Formula (C1) may be substituted with a halogen atom, an alkyl group having 1 or more and 5 or less carbon atoms, an alkoxy group having 1 or more and 5 or less carbon atoms, or a substituted amino group substituted with an alkyl group having 1 or more and 3 or less carbon atoms.

From the viewpoint of charge mobility, as the chemical substance (C1), for example, a chemical substance having at least one of an aryl group or —C₆H₄—CH═CH—CH═C(R^{T7})(R^{T8}) is preferable, and a chemical substance (C′ 1) represented by Formula (C′ 1) is more preferable.

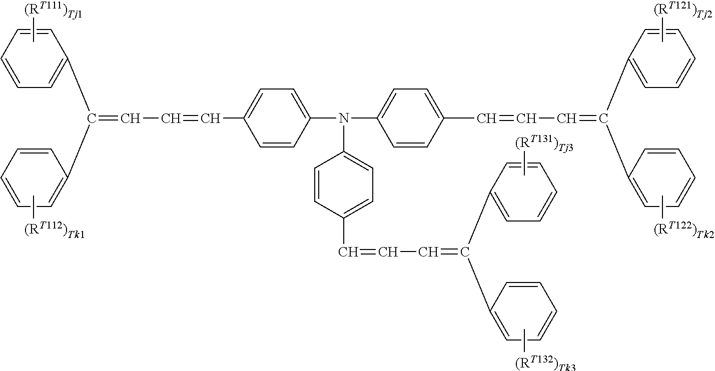

In Formula (C′ 1), R^{T111}, R^{T112}, R^{T121}, R^{T122}, R^{T131}, and R^{T132} are each independently a hydrogen atom, a halogen atom, an alkyl group (for example, preferably an alkyl group having 1 or more and 3 or less carbon atoms), an alkoxy group (for example, preferably an alkoxy group having 1 or more and 3 or less carbon atoms), a phenyl group, or a phenoxy group. Tj1, Tj2, Tj3, Tk1, Tk2, and Tk3 are each independently 0, 1, or 2.

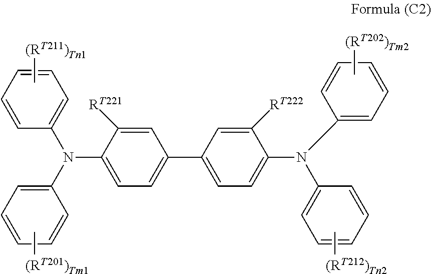

In Formula (C2), R^{T201}, R^{T202}, R^{T211}, and R^{T212} are each independently a halogen atom, an alkyl group having 1 or more and 5 or less carbon atoms, an alkoxy group having 1 or more and 5 or less carbon atoms, an amino group substituted with an alkyl group having 1 or 2 carbon atoms, an aryl group, —C(R^{T21})═C(R^{T22})(R^{T23}), or —CH═CH—CH═C(R^{T24})(R^{T25}). R^{T21}, R^{T22}, R^{T23}R^{T24}, and R^{T25} are each independently a hydrogen atom, an alkyl group, or an aryl group. R^{T221} and R^{T222} are each independently a hydrogen atom, a halogen atom, an alkyl group having 1 or more and 5 or less carbon atoms, or an alkoxy group having 1 or more and 5 or less carbon atoms. Tm1, Tm2, Tn1, and Tn2 are each independently 0, 1, or 2.

The group in Formula (C2) may be substituted with a halogen atom, an alkyl group having 1 or more and 5 or less carbon atoms, an alkoxy group having 1 or more and 5 or less carbon atoms, or a substituted amino group substituted with an alkyl group having 1 or more and 3 or less carbon atoms.

From the viewpoint of the charge mobility, as the chemical substance (C2), for example, a chemical substance having at least one of an alkyl group, an aryl group, or —CH═CH—CH═C(R^{T24})(R^{T25}) is preferable, and a chemical substance having two of an alkyl group, an aryl group, or —CH═CH—CH═C(R^{T24})(R^{T25}) is more preferable.

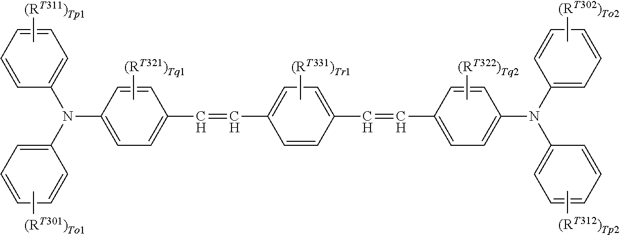

In Formula (C3), R^{T301}, R^{T302}, R^{T311}, and R^{T312} are each independently a halogen atom, an alkyl group having 1 or more and 5 or less carbon atoms, an alkoxy group having 1 or more and 5 or less carbon atoms, an amino group substituted with an alkyl group having 1 or 2 carbon atoms, an aryl group, —C(R^{T31})═C(R^{T32})(R^{T33}), or —CH═CH—CH═C(R^{T34})(R^{T35}). R^{T31}, R^{T32}, R^{T33}R^{T34}, and R^{T35} are each independently a hydrogen atom, an alkyl group, or an aryl group. R^{T321}, R^{T322}, and R^{T331} are each independently a hydrogen atom, a halogen atom, an alkyl group having 1 or more and 5 or less carbon atoms, or an alkoxy group having 1 or more and 5 or less carbon atoms. To1, To2, Tp1, Tp2, Tq1, Tq2, and Tr are each independently 0, 1, or 2.

The group in Formula (C3) may be substituted with a halogen atom, an alkyl group having 1 or more and 5 or less carbon atoms, an alkoxy group having 1 or more and 5 or less carbon atoms, or a substituted amino group substituted with an alkyl group having 1 or more and 3 or less carbon atoms.

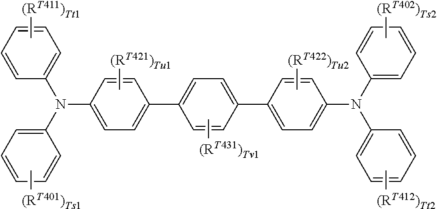

In Formula (C4), R^{T401}, R^{T402}, R^{T411}, and R^{T412} are each independently a halogen atom, an alkyl group having 1 or more and 5 or less carbon atoms, an alkoxy group having 1 or more and 5 or less carbon atoms, an amino group substituted with an alkyl group having 1 or 2 carbon atoms, an aryl group, —C(R^{T41})═C(R^{T42})(R^{T43}), or —CH═CH—CH═C(R^{T44})(R^{T45}). R^{T41}, R^{T42}, R^{T43}R^{T44}, and R^{T45} are each independently a hydrogen atom, an alkyl group, or an aryl group. R^{T421}, R^{T422}, and R^{T431} are each independently a hydrogen atom, a halogen atom, an alkyl group having 1 or more and 5 or less carbon atoms, or an alkoxy group having 1 or more and 5 or less carbon atoms. Ts1, Ts2, Tt1, Tt2, Tu1, Tu2, and Tv1 are each independently 0, 1, or 2.

The group in Formula (C4) may be substituted with a halogen atom, an alkyl group having 1 or more and 5 or less carbon atoms, an alkoxy group having 1 or more and 5 or less carbon atoms, or a substituted amino group substituted with an alkyl group having 1 or more and 3 or less carbon atoms.

The content of the charge transport material contained in the charge transport layer is, for example, preferably 20% by mass or more and 70% by mass or less with respect to the total mass of the charge transport layer.

Examples of the binder resin used for the charge transport layer include a polycarbonate resin, a polyester resin, a polyarylate resin, a methacrylic resin, an acrylic resin, a polyvinyl chloride resin, a polyvinylidene chloride resin, a polystyrene resin, a polyvinyl acetate resin, a styrene-butadiene copolymer, a vinylidene chloride-acrylonitrile copolymer, a vinyl chloride-vinyl acetate copolymer, a vinyl chloride-vinyl acetate-maleic anhydride copolymer, a silicone resin, a silicone alkyd resin, a phenol-formaldehyde resin, a styrene-alkyd resin, poly-N-vinylcarbazole, and polysilane. The binder resins are used alone or in combination of two or more kinds thereof.

A blending ratio between the charge transport material and the binder resin is, for example, preferably 10:1 to 1:5 in terms of mass ratio.

Among these, from the viewpoint of improving the abrasion resistance, as the binder resin, for example, at least one of a polyarylate resin or a polycarbonate resin is preferable.

From the same viewpoint, the total proportion of the polyarylate resin and the polycarbonate resin in the entire binder resin is, for example, preferably 90% by mass or more, and more preferably 95% by mass or more.

In particular, the proportion of the polyarylate resin in the entire binder resin is, for example, preferably 20% by mass or more and 80% by mass or less, more preferably 25% by mass or more and 75% by mass or less, and still more preferably 30% by mass or more and 70% by mass or less.

### Polyarylate Resin

As the polyarylate resin, known polyarylate resins can be adopted, but from the viewpoint of improving the abrasion resistance, for example, a polyarylate resin having a dicarboxylic acid unit (A) represented by Formula (A) and a diol unit (B) represented by Formula (B) (hereinafter also referred to as “polyarylate resin (PA)”) is preferable.

The dicarboxylic acid unit (A) is a constitutional unit represented by Formula (A).

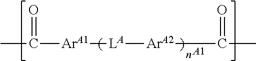

In Formula (A), Ar^{A1} and Ar^{A2} are each independently an aromatic ring that may have a substituent, L^{A} is a single bond or a divalent linking group, and n^{A} is 0, 1, or 2.

The aromatic ring as Ar^{A1} may be a monocycle or a polycycle. Examples of the aromatic ring include a benzene ring, a naphthalene ring, an anthracene ring, and a phenanthrene ring. Among the above, for example, a benzene ring or a naphthalene ring is preferable.

A hydrogen atom on the aromatic ring as Ar^{A1} may be substituted with an alkyl group, an aryl group, an aralkyl group, an alkoxy group, an aryloxy group, a halogen atom, or the like. As the substituent in a case where the aromatic ring as Ar^{A1} is substituted, for example, an alkyl group having 1 or more and 10 or less carbon atoms, an aryl group having 6 or more and 12 or less carbon atoms, or an alkoxy group having 1 or more and 6 or less carbon atoms is preferable.

The aromatic ring as Ar^{A2} may be a monocycle or a polycycle. Examples of the aromatic ring include a benzene ring, a naphthalene ring, an anthracene ring, and a phenanthrene ring. Among the above, for example, a benzene ring or a naphthalene ring is preferable.

A hydrogen atom on the aromatic ring as Ar^{A2} may be substituted with an alkyl group, an aryl group, an aralkyl group, an alkoxy group, an aryloxy group, a halogen atom, or the like.

As the substituent in a case where the aromatic ring as Ar_{A2} is substituted, for example, an alkyl group having 1 or more and 10 or less carbon atoms, an aryl group having 6 or more and 12 or less carbon atoms, or an alkoxy group having 1 or more and 6 or less carbon atoms is preferable.

In a case where L^{A} is a divalent linking group, examples of the divalent linking group include an oxygen atom, a sulfur atom, and —C(Ra¹)(Ra²)—. Here, Ra¹ and Ra² are each independently a hydrogen atom, an alkyl group having 1 or more and 10 or less carbon atoms, an aryl group having 6 or more and 12 or less carbon atoms, or an aralkyl group having 7 or more and 20 or less carbon atoms, and Ra¹ and Ra² may be bonded to each other to form a cyclic alkyl group.

The alkyl group having 1 or more and 10 or less carbon atoms, as Ra¹ and Ra², may be linear, branched, or cyclic. The number of carbon atoms of the alkyl group is, for example, preferably 1 or more and 6 or less, more preferably 1 or more and 4 or less, and still more preferably 1 or 2.

The aryl group having 6 or more and 12 or less carbon atoms, as Ra¹ and Ra², may be a monocycle or a polycycle. The number of carbon atoms in the aryl group is, for example, preferably 6 or more and 10 or less, and more preferably 6.

An alkyl group of the aralkyl group having 7 or more and 20 or less carbon atoms, as Ra¹ and Ra², may be linear, branched, or cyclic. The number of carbon atoms in the alkyl group of the aralkyl group having 7 or more and 20 or less carbon atoms is, for example, preferably 1 or more and 4 or less, more preferably 1 or more and 3 or less, and still more preferably 1 or 2.

An aryl group of the aralkyl group having 7 or more and 20 or less carbon atoms, as Ra¹ and Ra², may be a monocycle or a polycycle. The number of carbon atoms in the aryl group is, for example, preferably 6 or more and 10 or less, and more preferably 6.

The dicarboxylic acid unit (A) preferably includes, for example, at least one selected from the group consisting of a dicarboxylic acid unit (A1) represented by Formula (A1), a dicarboxylic acid unit (A2) represented by Formula (A2), a dicarboxylic acid unit (A3) represented by Formula (A3), a dicarboxylic acid unit (A4) represented by Formula (A4), and a dicarboxylic acid unit (A5) represented by Formula (A5). The dicarboxylic acid unit (A) includes, for example, more preferably at least one selected from the group consisting of a dicarboxylic acid unit (A2), a dicarboxylic acid unit (A3), and a dicarboxylic acid unit (A4) and still more preferably a dicarboxylic acid unit (A2).

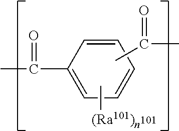

In Formula (A1), n¹⁰¹ is an integer of 0 or more and 4 or less, and n¹⁰¹ pieces of Ra¹⁰¹'s are each independently an alkyl group having 1 or more and 10 or less carbon atoms, an aryl group having 6 or more and 12 or less carbon atoms, or an alkoxy group having 1 or more and 6 or less carbon atoms.

n¹⁰¹ is, for example, preferably 0, 1, or 2, more preferably 0 or 1, and still more preferably 0.

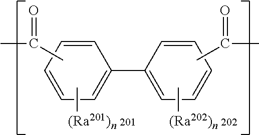

In Formula (A2), n²⁰¹ and n²⁰² are each independently an integer of 0 or more and 4 or less, and n²⁰¹ pieces of Ra²⁰¹'s and n²⁰² pieces of Ra²⁰²'s are each independently an alkyl group having 1 or more and 10 or less carbon atoms, an aryl group having 6 or more and 12 or less carbon atoms, or an alkoxy group having 1 or more and 6 or less carbon atoms.

n²⁰¹ represents, for example, preferably 0, 1, or 2, more preferably 0 or 1, and still more preferably 0.

n²⁰² represents, for example, preferably 0, 1, or 2, more preferably 0 or 1, and still more preferably 0.

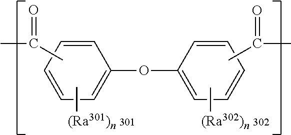

In Formula (A3), n³⁰¹ and n³⁰² are each independently an integer of 0 or greater and 4 or less, and n³⁰¹ pieces of Ra³⁰¹'s and n³⁰² pieces of Ra³⁰²'s are each independently an alkyl group having 1 or more and 10 or less carbon atoms, an aryl group having 6 or more and 12 or less carbon atoms, or an alkoxy group having 1 or more and 6 or less carbon atoms.

n³⁰¹ is, for example, preferably 0, 1, or 2, more preferably 0 or 1, and still more preferably 0.

n³⁰² is, for example, preferably 0, 1, or 2, more preferably 0 or 1, and still more preferably 0.

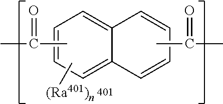

In Formula (A4), n⁴⁰¹ is an integer of 0 or greater and 6 or less, and n⁴⁰¹ pieces of Ra⁴⁰¹'s are each independently an alkyl group having 1 or more and 10 or less carbon atoms, an aryl group having 6 or more and 12 or less carbon atoms, or an alkoxy group having 1 or more and 6 or less carbon atoms.

n⁴⁰¹ represents, for example, preferably an integer of 0 or more and 4 or less, more preferably 0, 1, or 2, and still more preferably 0.

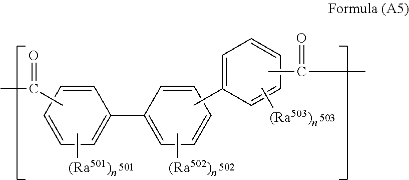

In Formula (A5), n⁵⁰¹, n⁵⁰², and n⁵⁰³ are each independently an integer of 0 or greater and 4 or less, and n⁵⁰¹ pieces of Ra⁵⁰¹'s, n⁵⁰² pieces of Ra⁵⁰²'s, and n⁵⁰³ pieces of Ra⁵⁰³'s are each independently an alkyl group having 1 or more and 10 or less carbon atoms, an aryl group having 6 or more and 12 or less carbon atoms, or an alkoxy group having 1 or more and 6 or less carbon atoms.

n⁵⁰¹ represents, for example, preferably 0, 1, or 2, more preferably 0 or 1, and still more preferably 0.

n⁵⁰² represents, for example, preferably 0, 1, or 2, more preferably 0 or 1, and still more preferably 0.

n⁵⁰³ represents, for example, preferably 0, 1, or 2, more preferably 0 or 1, and still more preferably 0.

The specific aspects and the preferred forms of Ra¹⁰¹ in Formula (A1), Ra²⁰¹ and Ra²⁰² in Formula (A2), Ra³⁰¹ and Ra³⁰² in Formula (A3), Ra⁴⁰¹ in Formula (A4), and Ra⁵⁰¹, Ra⁵⁰², and Ra⁵⁰³ in Formula (A5) are the same as each other, and hereinafter, Ra⁵⁰¹, Ra²⁰¹, Ra²⁰², Ra³⁰¹, Ra³⁰², Ra⁴⁰¹, Ra⁵⁰¹, Ra⁵⁰², and Ra⁵⁰³ will be collectively referred to as “Ra”.

The alkyl group having 1 or more and 10 or less carbon atoms as Ra may be linear, branched, or cyclic. The number of carbon atoms of the alkyl group is, for example, preferably 1 or more and 6 or less, more preferably 1 or more and 4 or less, and still more preferably 1 or 2.

Examples of the linear alkyl group having 1 or more and 10 or less carbon atoms include a methyl group, an ethyl group, a n-propyl group, a n-butyl group, a n-pentyl group, a n-hexyl group, a n-heptyl group, a n-octyl group, a n-nonyl group, and a n-decyl group.

Examples of the branched alkyl group having 3 or more and 10 or less carbon atoms include an isopropyl group, an isobutyl group, a sec-butyl group, a tert-butyl group, an isopentyl group, a neopentyl group, a tert-pentyl group, an isohexyl group, a sec-hexyl group, a tert-hexyl group, an isoheptyl group, a sec-heptyl group, a tert-heptyl group, an isooctyl group, a sec-octyl group, a tert-octyl group, an isononyl group, a sec-nonyl group, a tert-nonyl group, an isodecyl group, a sec-decyl group, and a tert-decyl group.

Examples of the cyclic alkyl group having 3 or more and 10 or less carbon atoms include a cyclopropyl group, a cyclobutyl group, a cyclopentyl group, a cyclohexyl group, a cycloheptyl group, a cyclooctyl group, a cyclononyl group, a cyclodecyl group, and polycyclic (for example, bicyclic, tricyclic, or spirocyclic) alkyl groups to which these monocyclic alkyl groups are linked.

The aryl group having 6 or more and 12 or less carbon atoms as Ra may be a monocycle or a polycycle. The number of carbon atoms in the aryl group is, for example, preferably 6 or more and 10 or less, and more preferably 6.

Examples of the aryl group having 6 or more and 12 or less carbon atoms include a phenyl group, a biphenyl group, a 1-naphthyl group, and a 2-naphthyl group.

The alkyl group in the alkoxy group having 1 or more and 6 or less carbon atoms as Ra may be linear, branched, or cyclic. The number of carbon atoms in the alkyl group of the alkoxy group having 1 or more and 6 or less carbon atoms is, for example, preferably 1 or more and 4 or less, more preferably 1 or more and 3 or less, and still more preferably 1 or 2.

Examples of the linear alkoxy group having 1 or more and 6 or less carbon atoms include a methoxy group, an ethoxy group, a n-propoxy group, a n-butoxy group, a n-pentyloxy group, and a n-hexyloxy group.

Examples of the branched alkoxy group having 3 or more and 6 or less carbon atoms include an isopropoxy group, an isobutoxy group, a sec-butoxy group, a tert-butoxy group, an isopentyloxy group, a neopentyloxy group, a tert-pentyloxy group, an isohexyloxy group, a sec-hexyloxy group, and a tert-hexyloxy group.

Examples of the cyclic alkoxy group having 3 or more and 6 or less carbon atoms include a cyclopropoxy group, a cyclobutoxy group, a cyclopentyloxy group, and a cyclohexyloxy group.

Hereinafter, dicarboxylic acid units (A1-1) to (A1-9) are shown as specific examples of the dicarboxylic acid unit (A1). The dicarboxylic acid unit (A1) is not limited thereto.

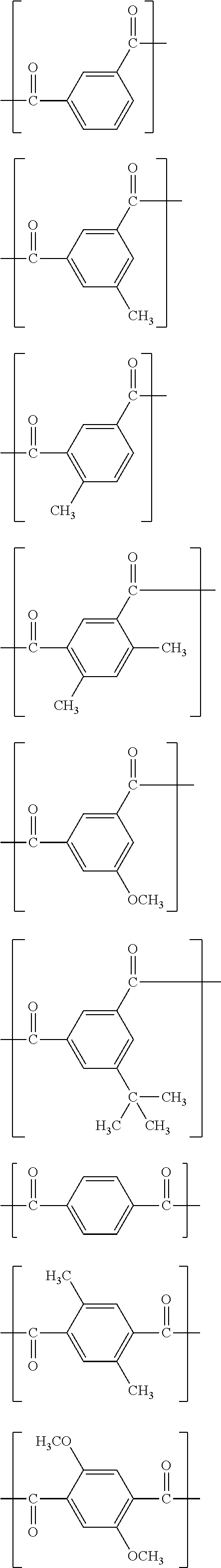

Hereinafter, dicarboxylic acid units (A2-1) to (A2-3) are shown as specific examples of the dicarboxylic acid unit (A2). The dicarboxylic acid unit (A2) is not limited thereto.

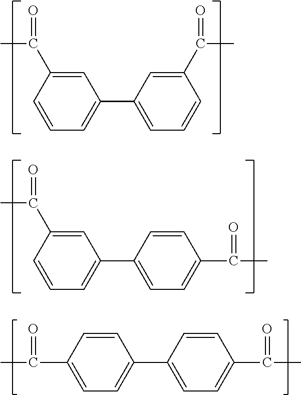

Hereinafter, dicarboxylic acid units (A3-1) and (A3-2) are shown as specific examples of the dicarboxylic acid unit (A3). The dicarboxylic acid unit (A3) is not limited thereto.

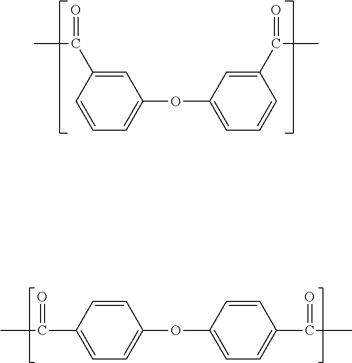

Hereinafter, dicarboxylic acid units (A4-1) to (A4-3) are shown as specific examples of the dicarboxylic acid unit (A4). The dicarboxylic acid unit (A4) is not limited thereto.

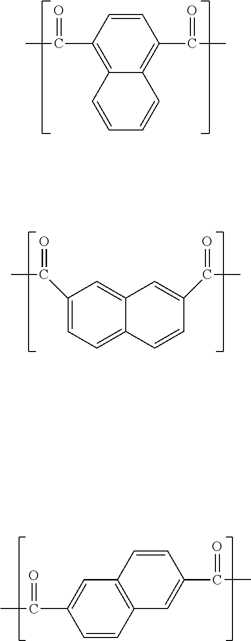

Hereinafter, dicarboxylic acid units (A5-1) to (A5-4) are shown as specific examples of the dicarboxylic acid unit (A5). The dicarboxylic acid unit (A5) is not limited thereto.

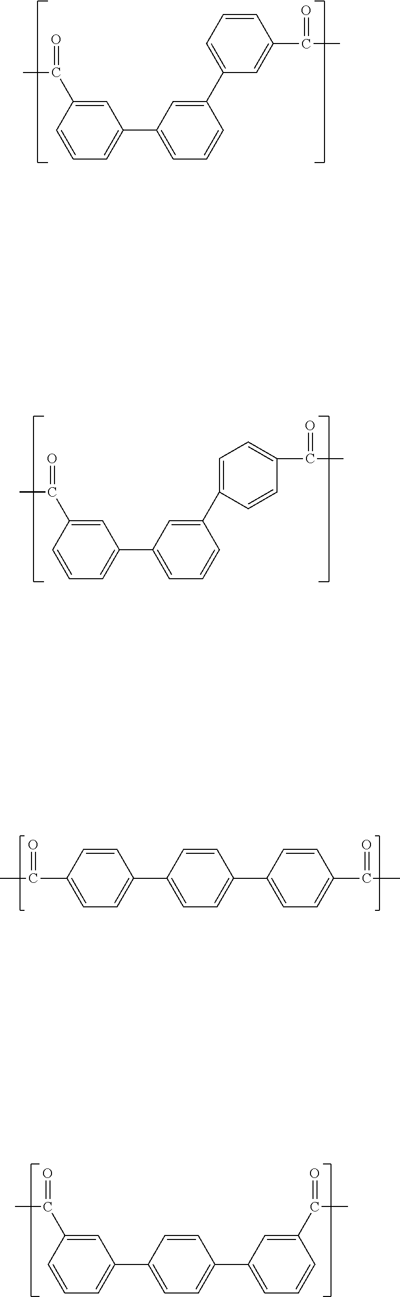

In the above-described specific examples, for example, at least one selected from the group consisting of (A1-1), (A1-7), (A2-3), (A3-2), and (A4-3) is preferably included, at least one selected from the group consisting of (A2-3), (A3-2), and (A4-3) is more preferably included, and at least (A2-3) is still more preferably included as the dicarboxylic acid unit (A).

The dicarboxylic acid unit (A) included in the polyarylate resin (PA) may be used alone or in combination of two or more kinds thereof.

A mass proportion of the dicarboxylic acid unit (A) in the polyarylate resin (PA) is, for example, preferably 15% by mass or more and 60% by mass or less.

In a case where the mass proportion of the dicarboxylic acid unit (A) is 15% by mass or more, the abrasion resistance of the charge transport layer is enhanced. From the viewpoint, the mass proportion of the dicarboxylic acid unit (A) is, for example, more preferably 20% by mass or more, and still more preferably 25% by mass or more.

In a case where the mass proportion of the dicarboxylic acid unit (A) is 60% by mass or less, peeling of the charge transport layer can be suppressed. From the viewpoint, the mass proportion of the dicarboxylic acid unit (A) is, for example, more preferably 55% by mass or less, and still more preferably 50% by mass or less.

The polyarylate resin (PA) may have other dicarboxylic acid units in addition to the dicarboxylic acid unit (A). Examples of other dicarboxylic acid units include aliphatic dicarboxylic acids (such as oxalic acid, malonic acid, maleic acid, fumaric acid, citraconic acid, itaconic acid, glutaconic acid, succinic acid, alkenyl succinic acid, adipic acid, and sebacic acid) units, alicyclic dicarboxylic acid (such as cyclohexanedicarboxylic acid) units, and lower alkyl ester units (for example, having 1 or more and 5 or less carbon atoms) thereof. The dicarboxylic acid units included in the polyarylate resin (PA) may be used alone or in combination of two or more kinds thereof.

The diol unit (B) is a constitutional unit represented by Formula (B).

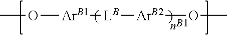

In Formula (B), Ar^{B1} and Ar^{B2} are each independently an aromatic ring that may have a substituent, L^{B} is a single bond, an oxygen atom, a sulfur atom, or —C(Rb¹)(Rb²)—, and n^{B1} is 0, 1, or 2. Rb¹ and Rb² are each independently a hydrogen atom, an alkyl group having 1 or more and 20 or less carbon atoms, an aryl group having 6 or more and 12 or less carbon atoms, or an aralkyl group having 7 or more and 20 or less carbon atoms, and Rb¹ and Rb² may be bonded to each other to form a cyclic alkyl group.

The aromatic ring as Ar^{B1} may be a monocycle or a polycycle. Examples of the aromatic ring include a benzene ring, a naphthalene ring, an anthracene ring, and a phenanthrene ring. Among the above, for example, a benzene ring or a naphthalene ring is preferable.

A hydrogen atom on the aromatic ring as Ar^{B1} may be substituted with an alkyl group, an aryl group, an aralkyl group, an alkoxy group, an aryloxy group, a halogen atom, or the like. As the substituent in a case where the aromatic ring as Ar^{B1} is substituted, for example, an alkyl group having 1 or more and 10 or less carbon atoms, an aryl group having 6 or more and 12 or less carbon atoms, or an alkoxy group having 1 or more and 6 or less carbon atoms is preferable.

The aromatic ring as Ar^{B2} may be a monocycle or a polycycle. Examples of the aromatic ring include a benzene ring, a naphthalene ring, an anthracene ring, and a phenanthrene ring. Among the above, for example, a benzene ring or a naphthalene ring is preferable.

A hydrogen atom on the aromatic ring as Ar^{B2} may be substituted with an alkyl group, an aryl group, an aralkyl group, an alkoxy group, an aryloxy group, a halogen atom, or the like.

As the substituent in a case where the aromatic ring as Ar^{B2} is substituted, for example, an alkyl group having 1 or more and 10 or less carbon atoms, an aryl group having 6 or more and 12 or less carbon atoms, or an alkoxy group having 1 or more and 6 or less carbon atoms is preferable.

The alkyl group having 1 or more and 20 or less carbon atoms, as Rb¹ and Rb², may be linear, branched, or cyclic. The number of carbon atoms in the alkyl group is, for example, preferably 1 or more and 18 or less, more preferably 1 or more and 14 or less, and still more preferably 1 or more and 10 or less.

The aryl group having 6 or more and 12 or less carbon atoms, as Rb¹ and Rb², may be a monocycle or a polycycle. The number of carbon atoms in the aryl group is, for example, preferably 6 or more and 10 or less, and more preferably 6.

An alkyl group of the aralkyl group having 7 or more and 20 or less carbon atoms, as Rb¹ and Rb², may be linear, branched, or cyclic. The number of carbon atoms in the alkyl group of the aralkyl group having 7 or more and 20 or less carbon atoms is, for example, preferably 1 or more and 4 or less, more preferably 1 or more and 3 or less, and still more preferably 1 or 2.

An aryl group of the aralkyl group having 7 or more and 20 or less carbon atoms, as Rb¹ and Rb², may be a monocycle or a polycycle. The number of carbon atoms in the aryl group is, for example, preferably 6 or more and 10 or less, and more preferably 6.

For example, it is preferable that the diol unit (B) includes at least one selected from the group consisting of a diol unit (B1) represented by Formula (B1), a diol unit (B2) represented by Formula (B2), a diol unit (B3) represented by Formula (B3), a diol unit (B4) represented by Formula (B4), a diol unit (B5) represented by Formula (B5), a diol unit (B6) represented by Formula (B6), a diol unit (B7) represented by Formula (B7), and a diol unit (B8) represented by Formula (B8).

For example, it is more preferable that the diol unit (B) includes at least one selected from the group consisting of the diol unit (B1) represented by Formula (B1), the diol unit (B2) represented by Formula (B2), the diol unit (B4) represented by Formula (B4), the diol unit (B5) represented by Formula (B5), and the diol unit (B6) represented by Formula (B6);
it is still more preferable that the diol unit (B) includes at least one selected from the group consisting of the diol unit (B1) represented by Formula (B1), the diol unit (B2) represented by Formula (B2), the diol unit (B5) represented by Formula (B5), and the diol unit (B6) represented by Formula (B6);
it is even more preferable that the diol unit (B) includes at least one selected from the group consisting of the diol unit (B1) represented by Formula (B1), the diol unit (B2) represented by Formula (B2), and the diol unit (B6) represented by Formula (B6); and
it is most preferable that the diol unit (B) includes at least one selected from the group consisting of the diol unit (B1) represented by Formula (B1) and the diol unit (B2) represented by Formula (B2).

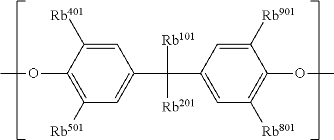

In Formula (B1), Rb¹⁰¹ is a branched alkyl group having 4 or more and 20 or less carbon atoms, Rb²⁰¹ is a hydrogen atom or an alkyl group having 1 or more and 3 or less carbon atoms, and Rb⁴⁰¹, Rb⁵⁰¹, Rb⁸⁰¹, and Rb⁹⁰¹ are each independently a hydrogen atom, an alkyl group having 1 or more and 4 or less carbon atoms, an alkoxy group having 1 or more and 6 or less carbon atoms, or a halogen atom.

The number of carbon atoms in the branched alkyl group having 4 or more and 20 or less carbon atoms, as Rb¹° 1, is, for example, preferably 4 or more and 16 or less, more preferably 4 or more and 12 or less, and still more preferably 4 or more and 8 or less. Specific examples of Rb¹⁰¹ include an isobutyl group, an sec-butyl group, a tert-butyl group, an isopentyl group, a neopentyl group, a tert-pentyl group, an isohexyl group, an sec-hexyl group, a tert-hexyl group, an isoheptyl group, an sec-heptyl group, a tert-heptyl group, an isooctyl group, an sec-octyl group, a tert-octyl group, an isononyl group, an sec-nonyl group, a tert-nonyl group, an isodecyl group, an sec-decyl group, a tert-decyl group, an isododecyl group, an sec-dodecyl group, a tert-dodecyl group, a tert-tetradecyl group, and a tert-pentadecyl group.

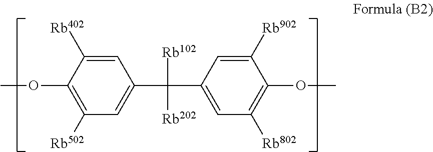

In Formula (B2), Rb¹⁰² is a linear alkyl group having 4 or more and 20 or less carbon atoms, Rb²⁰² is a hydrogen atom or an alkyl group having 1 or more and 3 or less carbon atoms, and Rb⁴⁰², Rb⁵⁰², Rb⁸⁰², and Rb⁹⁰² are each independently a hydrogen atom, an alkyl group having 1 or more and 4 or less carbon atoms, an alkoxy group having 1 or more and 6 or less carbon atoms, or a halogen atom.

The number of carbon atoms in the linear alkyl group having 4 or more and 20 or less carbon atoms, as Rb¹⁰², is, for example, preferably 4 or more and 16 or less, more preferably 4 or more and 12 or less, and still more preferably 4 or more and 8 or less. Specific examples of Rb¹⁰² include an n-butyl group, an n-pentyl group, an n-hexyl group, an n-heptyl group, an n-octyl group, an n-nonyl group, an n-decyl group, an n-undecyl group, an n-dodecyl group, a tridecyl group, an n-tetradecyl group, an n-pentadecyl group, an n-heptadecyl group, an n-octadecyl group, an n-nonadecyl group, and an n-icosyl group.

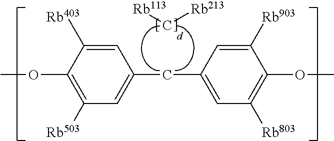

In Formula (B3), Rb¹¹³ and Rb²¹³ are each independently a hydrogen atom, a linear alkyl group having 1 or more and 3 or less carbon atoms, an alkoxy group having 1 or more and 4 or less carbon atoms, or a halogen atom, d is an integer of 7 or greater and 15 or less, and Rb⁴⁰³, Rb⁵⁰³, Rb⁸⁰³, and Rb⁹⁰³ are each independently a hydrogen atom, an alkyl group having 1 or more and 4 or less carbon atoms, an alkoxy group having 1 or more and 6 or less carbon atoms, or a halogen atom.

The number of carbon atoms in the linear alkyl group having 1 or more and 3 or less carbon atoms, as Rb¹¹³ and Rb²¹³, is, for example, preferably 1 or 2 and more preferably 1. Specific examples of such a group include a methyl group, an ethyl group, and a n-propyl group.

An alkyl group of the alkoxy group having 1 or more and 4 or less carbon atoms, as Rb¹¹³ and Rb²¹³, may be linear, branched, or cyclic. The number of carbon atoms in the alkyl group of the alkoxy group having 1 or more and 4 or less carbon atoms is, for example, preferably 1 or more and 3 or less, more preferably 1 or 2, and still more preferably 1. Specific examples of such a group include a methoxy group, an ethoxy group, a n-propoxy group, a n-butoxy group, an isopropoxy group, an isobutoxy group, a sec-butoxy group, a tert-butoxy group, a cyclopropoxy group, and a cyclobutoxy group.

Examples of the halogen atom as Rb¹¹³ and Rb²¹³ include a fluorine atom, a chlorine atom, a bromine atom, and an iodine atom.

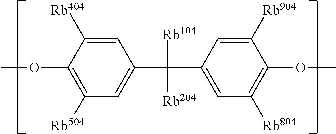

In Formula (B4), Rb¹⁰⁴ and Rb²⁰⁴ are each independently a hydrogen atom or an alkyl group having 1 or more and 3 or less carbon atoms, and Rb⁴⁰⁴, Rb⁵⁰⁴, Rb⁸⁰⁴, and Rb⁹⁰⁴ are each independently a hydrogen atom, an alkyl group having 1 or more and 4 or less carbon atoms, an alkoxy group having 1 or more and 6 or less carbon atoms, or a halogen atom.

The alkyl group having 1 or more and 3 or less carbon atoms, as Rb¹⁰⁴, may be linear, branched, or cyclic. The number of carbon atoms in the alkyl group is, for example, preferably 1 or 2 and more preferably 1. Specific examples of Rb¹⁰⁴ include a methyl group, an ethyl group, an n-propyl group, an isopropyl group, and a cyclopropyl group.

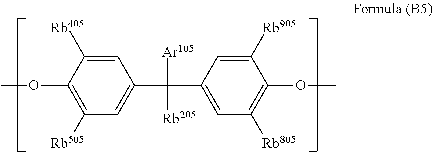

In Formula (B5), Ar¹⁰⁵ is an aryl group having 6 or more and 12 or less carbon atoms or an aralkyl group having 7 or more and 20 or less carbon atoms, Rb²⁰⁵ is a hydrogen atom or an alkyl group having 1 or more and 3 or less carbon atoms, and Rb⁴⁰⁵, Rb⁵⁰⁵, Rb⁸⁰⁵, and Rb⁹⁰⁵ are each independently a hydrogen atom, an alkyl group having 1 or more and 4 or less carbon atoms, an alkoxy group having 1 or more and 6 or less carbon atoms, or a halogen atom.

The aryl group having 6 or more and 12 or less carbon atoms, as Ar¹° 5, may be a monocycle or a polycycle. The number of carbon atoms in the aryl group is, for example, preferably 6 or more and 10 or less, and more preferably 6.

An alkyl group of the aralkyl group having 7 or more and 20 or less carbon atoms, as Ar¹⁰⁵, may be linear, branched, or cyclic. The number of carbon atoms in the alkyl group of the aralkyl group having 7 or more and 20 or less carbon atoms is, for example, preferably 1 or more and 4 or less, more preferably 1 or more and 3 or less, and still more preferably 1 or 2. An aryl group of the aralkyl group having 7 or more and 20 or less carbon atoms, as Ar¹⁰⁵, may be a monocycle or a polycycle. The number of carbon atoms in the aryl group is, for example, preferably 6 or more and 10 or less, and more preferably 6. Examples of the aralkyl group having 7 or more and 20 or less carbon atoms include a benzyl group, a phenylethyl group, a phenylpropyl group, a 4-phenylbutyl group, a phenylpentyl group, a phenylhexyl group, a phenylheptyl group, a phenyloctyl group, a phenylnonyl group, a naphthylmethyl group, a naphthylethyl group, an anthracenylmethyl group, and a phenyl-cyclopentylmethyl group.

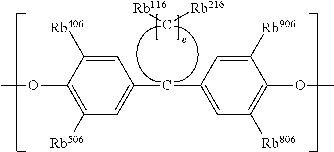

In Formula (B6), Rb¹¹⁶ and Rb²¹⁶ are each independently a hydrogen atom, a linear alkyl group having 1 or more and 3 or less carbon atoms, an alkoxy group having 1 or more and 4 or less carbon atoms, or a halogen atom, e is an integer of 4 or greater and 6 or less, and Rb⁴⁰⁶, Rb⁵⁰⁶, Rb⁸⁰⁶, and Rb⁹⁰⁶ are each independently a hydrogen atom, an alkyl group having 1 or more and 4 or less carbon atoms, an alkoxy group having 1 or more and 6 or less carbon atoms, or a halogen atom.

The number of carbon atoms in the linear alkyl group having 1 or more and 3 or less carbon atoms, as Rb¹¹⁶ and Rb²¹⁶, is, for example, preferably 1 or 2 and more preferably 1. Specific examples of such a group include a methyl group, an ethyl group, and a n-propyl group.

An alkyl group of the alkoxy group having 1 or more and 4 or less carbon atoms, as Rb¹¹⁶ and Rb²¹⁶, may be linear, branched, or cyclic. The number of carbon atoms in the alkyl group of the alkoxy group having 1 or more and 4 or less carbon atoms is, for example, preferably 1 or more and 3 or less, more preferably 1 or 2, and still more preferably 1. Specific examples of such a group include a methoxy group, an ethoxy group, a n-propoxy group, a n-butoxy group, an isopropoxy group, an isobutoxy group, a sec-butoxy group, a tert-butoxy group, a cyclopropoxy group, and a cyclobutoxy group.

Examples of the halogen atom as Rb¹¹⁶ and Rb²¹⁶ include a fluorine atom, a chlorine atom, a bromine atom, and an iodine atom.

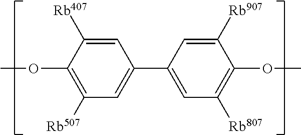

In Formula (B7), Rb⁴⁰⁷, Rb⁵⁰⁷, Rb⁸⁰⁷, and Rb⁹⁰⁷ are each independently a hydrogen atom, an alkyl group having 1 or more and 4 or less carbon atoms, an alkoxy group having 1 or more and 6 or less carbon atoms, or a halogen atom.

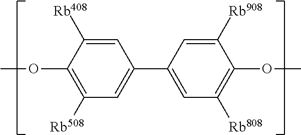

In Formula (B8), Rb⁴⁰⁸, Rb⁵⁰⁸, Rb⁸⁰⁸, and Rb⁹⁰⁸ are each independently a hydrogen atom, an alkyl group having 1 or more and 4 or less carbon atoms, an alkoxy group having 1 or more and 6 or less carbon atoms, or a halogen atom.

Specific aspects and preferred aspects of Rb²⁰¹ in Formula (B1), Rb²⁰² in Formula (B2), Rb²⁰⁴ in Formula (B4), and Rb²⁰⁵ in Formula (B5) are the same as each other, so that Rb²⁰¹, Rb²⁰², Rb²⁰⁴, and Rb²⁰⁵ will be collectively referred to as “Rb²⁰⁰”

The alkyl group having 1 or more and 3 or less carbon atoms, as Rb²⁰⁰, may be linear, branched, or cyclic. The number of carbon atoms in the alkyl group is, for example, preferably 1 or 2 and more preferably 1.

Examples of the alkyl group having 1 or more and 3 or less carbon atoms include a methyl group, an ethyl group, a n-propyl group, an isopropyl group, and a cyclopropyl group.

Specific forms and preferred forms of Rb⁴⁰¹ in Formula (B1), Rb⁴⁰² in Formula (B2), Rb⁴⁰³ in Formula (B3), Rb⁴⁰⁴ in Formula (B4), Rb⁴⁰⁵ in Formula (B5), Rb⁴⁰⁶ in Formula (B6), Rb⁴⁰⁷ in Formula (B7), and Rb⁴⁰⁸ in Formula (B8) are the same as each other, so that Rb⁴⁰¹, Rb⁴⁰², Rb⁴⁰³, Rb⁴⁰⁴, Rb⁴⁰⁵, Rb⁴⁰⁶, Rb⁴⁰⁷, and Rb⁴⁰⁸ will be collectively referred to as “Rb⁴⁰⁰”.

The alkyl group having 1 or more and 4 or less carbon atoms, as Rb⁴⁰⁰, may be linear, branched, or cyclic. The number of carbon atoms in the alkyl group is, for example, preferably 1 or more and 3 or less, more preferably 1 or 2, and still more preferably 1.

Examples of the linear alkyl group having 1 or more and 4 or less carbon atoms include a methyl group, an ethyl group, a n-propyl group, and a n-butyl group.

Examples of the branched alkyl group having 3 or 4 carbon atoms include an isopropyl group, an isobutyl group, a sec-butyl group, and a tert-butyl group.

Examples of the cyclic alkyl group having 3 or 4 carbon atoms include a cyclopropyl group and a cyclobutyl group.

An alkyl group of the alkoxy group having 1 or more and 6 or less carbon atoms, as Rb⁴⁰⁰, may be linear, branched, or cyclic. The number of carbon atoms in the alkyl group of the alkoxy group having 1 or more and 6 or less carbon atoms is, for example, preferably 1 or more and 4 or less, more preferably 1 or more and 3 or less, and still more preferably 1 or 2.

Examples of the linear alkoxy group having 1 or more and 6 or less carbon atoms include a methoxy group, an ethoxy group, a n-propoxy group, a n-butoxy group, a n-pentyloxy group, and a n-hexyloxy group.

Examples of the branched alkoxy group having 3 or more and 6 or less carbon atoms include an isopropoxy group, an isobutoxy group, a sec-butoxy group, a tert-butoxy group, an isopentyloxy group, a neopentyloxy group, a tert-pentyloxy group, an isohexyloxy group, a sec-hexyloxy group, and a tert-hexyloxy group.

Examples of the cyclic alkoxy group having 3 or more and 6 or less carbon atoms include a cyclopropoxy group, a cyclobutoxy group, a cyclopentyloxy group, and a cyclohexyloxy group.

Examples of the halogen atom as Rb⁴⁰⁰ include a fluorine atom, a chlorine atom, a bromine atom, and an iodine atom.

Specific aspects and preferred aspects of Rb⁵⁰¹ in Formula (B1), Rb⁵⁰² in Formula (B2), Rb⁵⁰³ in Formula (B3), Rb⁵⁰⁴ in Formula (B4), Rb⁵⁰⁵ in Formula (B5), Rb⁵⁰⁶ in Formula (B6), Rb⁵⁰⁷ in Formula (B7), and Rb⁵⁰⁸ in Formula (B8) are the same as each other, so that Rb⁵⁰¹, Rb⁵⁰², Rb⁵⁰³, Rb⁵⁰⁴, Rb⁵⁰⁵, Rb⁵⁰⁶, Rb⁵⁰⁷, and Rb⁵⁰⁸ will be collectively referred to as “Rb⁵⁰⁰”.

The alkyl group having 1 or more and 4 or less carbon atoms, as Rb⁵⁰⁰, may be linear, branched, or cyclic. The number of carbon atoms in the alkyl group is, for example, preferably 1 or more and 3 or less, more preferably 1 or 2, and still more preferably 1.

Examples of the linear alkyl group having 1 or more and 4 or less carbon atoms include a methyl group, an ethyl group, a n-propyl group, and a n-butyl group.

Examples of the branched alkyl group having 3 or 4 carbon atoms include an isopropyl group, an isobutyl group, a sec-butyl group, and a tert-butyl group.

Examples of the cyclic alkyl group having 3 or 4 carbon atoms include a cyclopropyl group and a cyclobutyl group.

An alkyl group of the alkoxy group having 1 or more and 6 or less carbon atoms, as Rb⁵⁰⁰, may be linear, branched, or cyclic. The number of carbon atoms in the alkyl group of the alkoxy group having 1 or more and 6 or less carbon atoms is, for example, preferably 1 or more and 4 or less, more preferably 1 or more and 3 or less, and still more preferably 1 or 2.

Examples of the linear alkoxy group having 1 or more and 6 or less carbon atoms include a methoxy group, an ethoxy group, a n-propoxy group, a n-butoxy group, a n-pentyloxy group, and a n-hexyloxy group.

Examples of the branched alkoxy group having 3 or more and 6 or less carbon atoms include an isopropoxy group, an isobutoxy group, a sec-butoxy group, a tert-butoxy group, an isopentyloxy group, a neopentyloxy group, a tert-pentyloxy group, an isohexyloxy group, a sec-hexyloxy group, and a tert-hexyloxy group.

Examples of the cyclic alkoxy group having 3 or more and 6 or less carbon atoms include a cyclopropoxy group, a cyclobutoxy group, a cyclopentyloxy group, and a cyclohexyloxy group.

Examples of the halogen atom as Rb⁵⁰⁰ include a fluorine atom, a chlorine atom, a bromine atom, and an iodine atom.

Specific aspects and preferred aspects of Rb⁸⁰¹ in Formula (B1), Rb⁸⁰² in Formula (B2), Rb⁸⁰³ in Formula (B3), Rb⁸⁰⁴ in Formula (B4), Rb⁸⁰⁵ in Formula (B5), Rb⁸⁰⁶ in Formula (B6), Rb⁸⁰⁷ in Formula (B7), and Rb⁸⁰⁸ in Formula (B8) are the same as each other, so that Rb⁸⁰⁰, Rb⁸⁰², Rb⁸⁰³, Rb⁸⁰⁴, Rb⁸⁰⁵, Rb⁸⁰⁶, Rb⁸⁰⁷, and Rb⁸⁰⁸ will be collectively referred to as “Rb⁸⁰⁰”.

The alkyl group having 1 or more and 4 or less carbon atoms, as Rb⁸⁰⁰, may be linear, branched, or cyclic. The number of carbon atoms in the alkyl group is, for example, preferably 1 or more and 3 or less, more preferably 1 or 2, and still more preferably 1.

Examples of the linear alkyl group having 1 or more and 4 or less carbon atoms include a methyl group, an ethyl group, a n-propyl group, and a n-butyl group.

Examples of the branched alkyl group having 3 or 4 carbon atoms include an isopropyl group, an isobutyl group, a sec-butyl group, and a tert-butyl group.

Examples of the cyclic alkyl group having 3 or 4 carbon atoms include a cyclopropyl group and a cyclobutyl group.

An alkyl group of the alkoxy group having 1 or more and 6 or less carbon atoms, as Rb⁸⁰⁰, may be linear, branched, or cyclic. The number of carbon atoms in the alkyl group of the alkoxy group having 1 or more and 6 or less carbon atoms is, for example, preferably 1 or more and 4 or less, more preferably 1 or more and 3 or less, and still more preferably 1 or 2.

Examples of the linear alkoxy group having 1 or more and 6 or less carbon atoms include a methoxy group, an ethoxy group, a n-propoxy group, a n-butoxy group, a n-pentyloxy group, and a n-hexyloxy group.

Examples of the branched alkoxy group having 3 or more and 6 or less carbon atoms include an isopropoxy group, an isobutoxy group, a sec-butoxy group, a tert-butoxy group, an isopentyloxy group, a neopentyloxy group, a tert-pentyloxy group, an isohexyloxy group, a sec-hexyloxy group, and a tert-hexyloxy group.

Examples of the cyclic alkoxy group having 3 or more and 6 or less carbon atoms include a cyclopropoxy group, a cyclobutoxy group, a cyclopentyloxy group, and a cyclohexyloxy group.

Examples of the halogen atom as Rb⁸⁰⁰ include a fluorine atom, a chlorine atom, a bromine atom, and an iodine atom.

Specific forms and preferred forms of Rb⁹⁰¹ in Formula (B1), Rb⁹⁰² in Formula (B2), Rb⁹⁰³ in Formula (B3), Rb⁹⁰⁴ in Formula (B4), Rb⁹⁰⁵ in Formula (B5), Rb⁹⁰⁶ in Formula (B6), Rb⁹⁰⁷ in Formula (B7), and Rb⁹⁰⁸ in Formula (B8) are the same as each other, so that Rb⁹⁰¹, Rb⁹⁰², Rb⁹⁰³, Rb⁹⁰⁴, Rb⁹⁰⁵, Rb⁹⁰⁶, Rb⁹⁰⁷, and Rb⁹⁰⁸ will be collectively referred to as “Rb⁹⁰⁰”.

The alkyl group having 1 or more and 4 or less carbon atoms, as Rb⁹⁰⁰, may be linear, branched, or cyclic. The number of carbon atoms in the alkyl group is, for example, preferably 1 or more and 3 or less, more preferably 1 or 2, and still more preferably 1.

Examples of the linear alkyl group having 1 or more and 4 or less carbon atoms include a methyl group, an ethyl group, a n-propyl group, and a n-butyl group.

Examples of the branched alkyl group having 3 or 4 carbon atoms include an isopropyl group, an isobutyl group, a sec-butyl group, and a tert-butyl group.

Examples of the cyclic alkyl group having 3 or 4 carbon atoms include a cyclopropyl group and a cyclobutyl group.

An alkyl group of the alkoxy group having 1 or more and 6 or less carbon atoms, as Rb⁹⁰⁰, may be linear, branched, or cyclic. The number of carbon atoms in the alkyl group of the alkoxy group having 1 or more and 6 or less carbon atoms is, for example, preferably 1 or more and 4 or less, more preferably 1 or more and 3 or less, and still more preferably 1 or 2.

Examples of the linear alkoxy group having 1 or more and 6 or less carbon atoms include a methoxy group, an ethoxy group, a n-propoxy group, a n-butoxy group, a n-pentyloxy group, and a n-hexyloxy group.

Examples of the branched alkoxy group having 3 or more and 6 or less carbon atoms include an isopropoxy group, an isobutoxy group, a sec-butoxy group, a tert-butoxy group, an isopentyloxy group, a neopentyloxy group, a tert-pentyloxy group, an isohexyloxy group, a sec-hexyloxy group, and a tert-hexyloxy group.

Examples of the cyclic alkoxy group having 3 or more and 6 or less carbon atoms include a cyclopropoxy group, a cyclobutoxy group, a cyclopentyloxy group, and a cyclohexyloxy group.

Examples of the halogen atom as Rb⁹⁰⁰ include a fluorine atom, a chlorine atom, a bromine atom, and an iodine atom.

Hereinafter, diol units (B1-1) to (B1-6) are shown as specific examples of the diol unit (B1). The diol unit (B1) is not limited thereto.

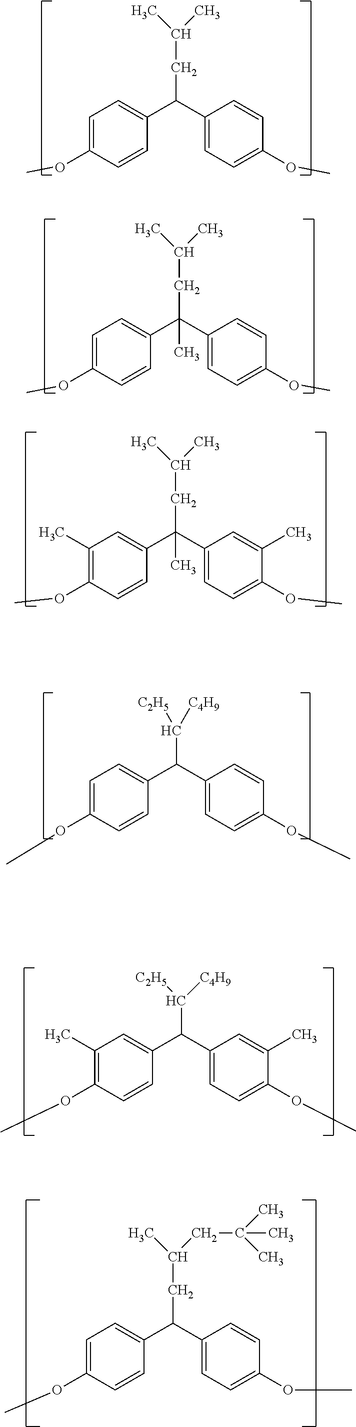

Hereinafter, diol units (B2-1) to (B2-11) are shown as specific examples of the diol unit (B2). The diol unit (B2) is not limited thereto.

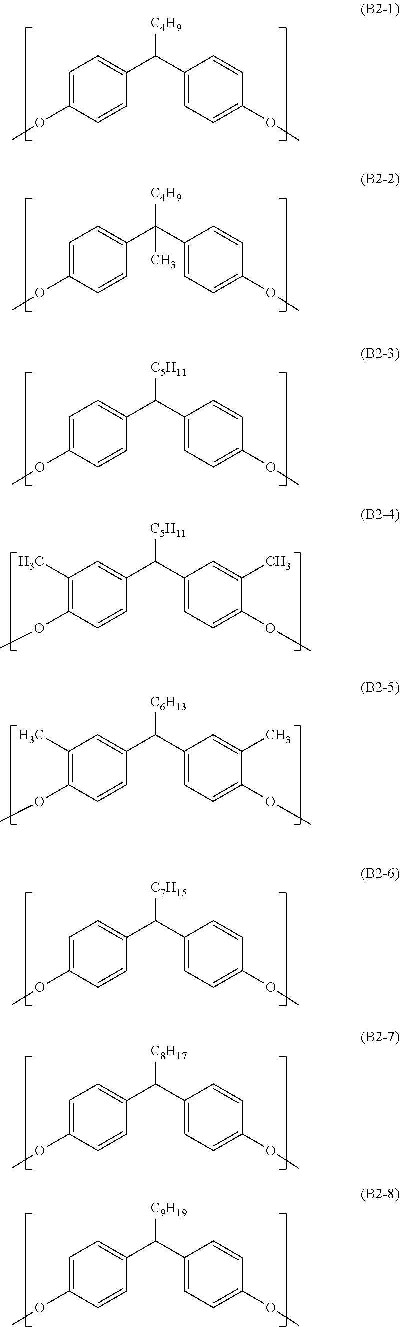

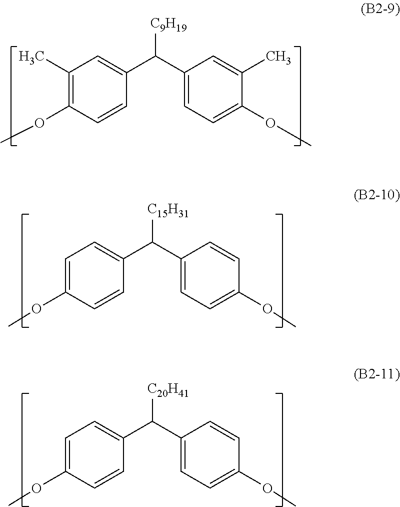

Hereinafter, diol units (B3-1) to (B3-4) are shown as specific examples of the diol unit (B3). The diol unit (B3) is not limited thereto.

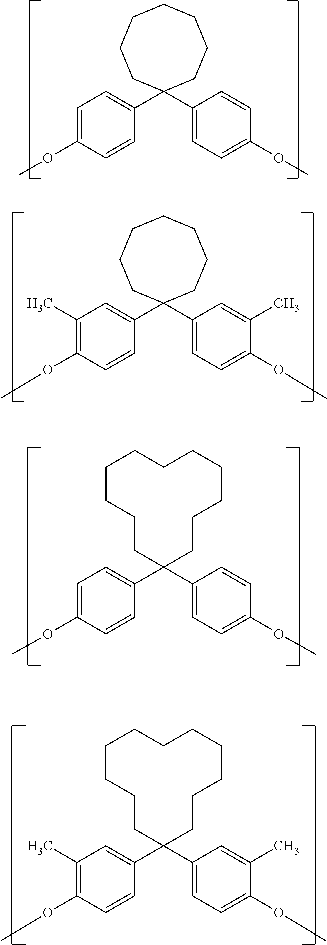

Hereinafter, diol units (B4-1) to (B4-7) are shown as specific examples of the diol unit (B4). The diol unit (B4) is not limited thereto.

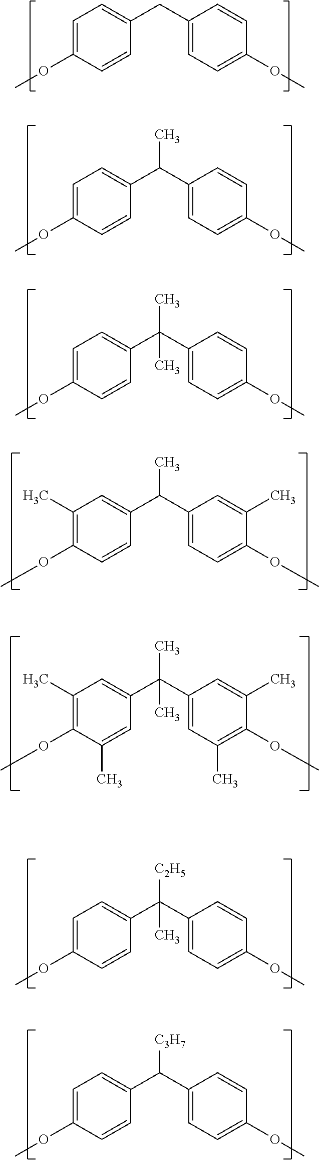

Hereinafter, diol units (B5-1) to (B5-6) are shown as specific examples of the diol unit (B5). The diol unit (B5) is not limited thereto.

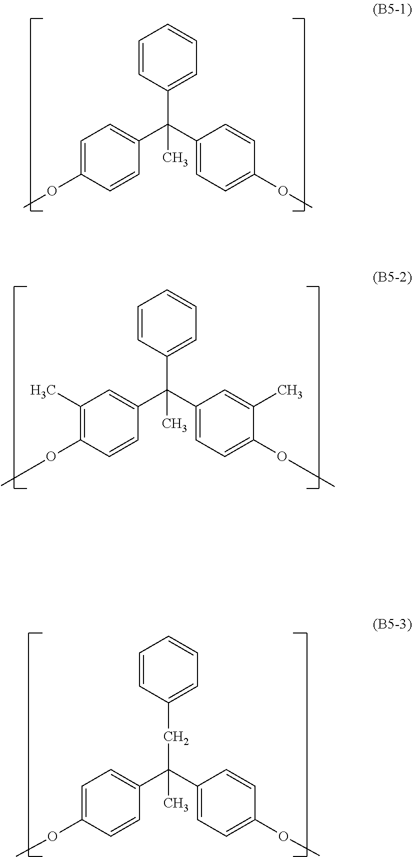

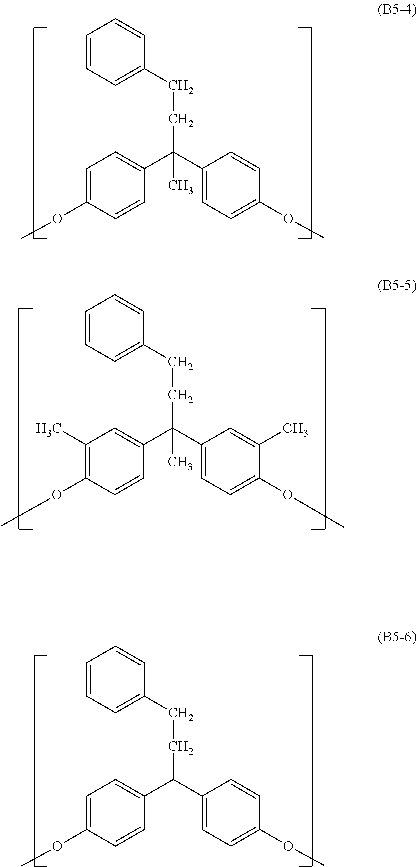

Hereinafter, diol units (B6-1) to (B6-4) are shown as specific examples of the diol unit (B6). The diol unit (B6) is not limited thereto.

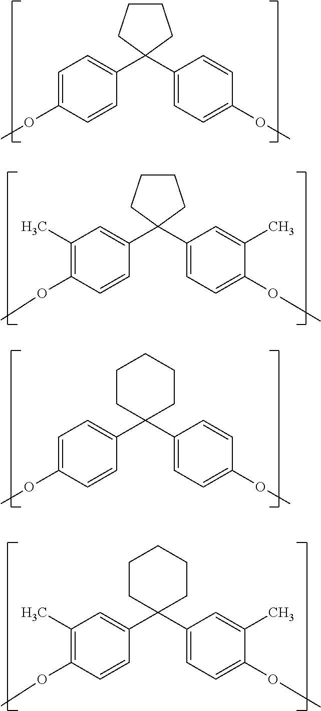

Hereinafter, diol units (B7-1) to (B7-3) are shown as specific examples of the diol unit (B7). The diol unit (B7) is not limited thereto.

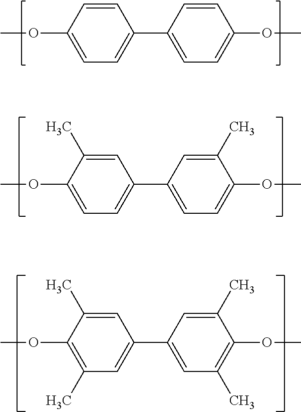

Hereinafter, diol units (B8-1) to (B8-3) are shown as specific examples of the diol unit (B8). The diol unit (B8) is not limited thereto.

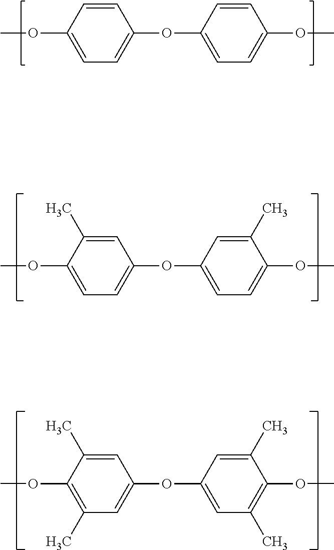

The diol unit (B) included in the polyarylate resin (PA) may be used alone or in combination of two or more kinds thereof.

A mass proportion of the diol unit (B) in the polyarylate resin (PA) is, for example, preferably 25% by mass or more and 80% by mass or less.

In a case where the mass proportion of the diol unit (B) is 25% by mass or more, peeling of the charge transport layer can be further suppressed. From the viewpoint, the mass proportion of the diol unit (B) is, for example, more preferably 30% by mass or more, and still more preferably 35% by mass or more.

In a case where the mass proportion of the diol unit (B) is 80% by mass or less, the solubility in a coating solution for forming the charge transport layer is maintained, and thus the abrasion resistance can be improved. From the viewpoint, the mass proportion of the diol unit (B) is, for example, more preferably 75% by mass or less and still more preferably 70% by mass or less.

The polyarylate resin (PA) may have other diol units in addition to the diol unit (B). Examples of other diol units include aliphatic diol (such as ethylene glycol, diethylene glycol, triethylene glycol, propylene glycol, butanediol, hexanediol, and neopentyl glycol) units, and alicyclic diol (such as cyclohexanediol, cyclohexanedimethanol, and hydrogenated bisphenol A) units. The diol units included in the polyarylate resin (PA) may be used alone or in combination of two or more kinds thereof.

A terminal of the polyarylate resin (PA) may be sealed or modified with a terminal-sealing agent, a molecular weight modifier, or the like used in a case of the production. Examples of the terminal-sealing agent or the molecular weight modifier include monohydric phenol, monovalent acid chloride, monohydric alcohol, and monovalent carboxylic acid.

Examples of the monohydric phenol include phenol, o-cresol, m-cresol, p-cresol, o-ethylphenol, m-ethylphenol, p-ethylphenol, o-propylphenol, m-propylphenol, p-propylphenol, o-tert-butylphenol, m-tert-butylphenol, p-tert-butylphenol, pentylphenol, hexylphenol, octylphenol, nonylphenol, a 2,6-dimethylphenol derivative, a 2-methylphenol derivative, o-phenylphenol, m-phenylphenol, p-phenylphenol, o-methoxyphenol, m-methoxyphenol, p-methoxyphenol, 2,3,5-trimethylphenol, 2,3,6-trimethylphenol, 2,3-xylenol, 2,4-xylenol, 2,5-xylenol, 2,6-xylenol, 3,4-xylenol, 3,5-xylenol, 2-phenyl-2-(4-hydroxyphenyl)propane, 2-phenyl-2-(2-hydroxyphenyl)propane, and 2-phenyl-2-(3-hydroxyphenyl)propane.

Examples of the monovalent acid chloride include monofunctional acid halides such as benzoyl chloride, benzoic acid chloride, methanesulfonyl chloride, phenylchloroformate, acetic acid chloride, butyric acid chloride, octyl acid chloride, benzenesulfonyl chloride, benzenesulfinyl chloride, sulfinyl chloride, benzene phosphonyl chloride, and substituents thereof.

Examples of the monohydric alcohol include methanol, ethanol, n-propanol, isopropanol, n-butanol, 2-butanol, pentanol, hexanol, dodecyl alcohol, stearyl alcohol, benzyl alcohol, and phenethyl alcohol.

Examples of the monovalent carboxylic acid include acetic acid, propionic acid, octanoic acid, cyclohexanecarboxylic acid, benzoic acid, toluic acid, phenylacetic acid, p-tert-butylbenzoic acid, and p-methoxyphenylacetic acid.

A weight-average molecular weight of the polyarylate resin (PA) is, for example, preferably 30,000 or more and 300,000 or less, more preferably 40,000 or more and 250,000 or less, and still more preferably 50,000 or more and 200,000 or less.

The molecular weight of the polyarylate resin (PA) is a molecular weight in terms of polystyrene measured by gel permeation chromatography (GPC). The GPC is carried out by using tetrahydrofuran as an eluent.

The polyarylate resin (PA) can be obtained by polycondensing a monomer providing the dicarboxylic acid unit (A), a monomer providing the diol unit (B), and other monomers as necessary using a method in the related art. Examples of the method of polycondensing monomers include an interfacial polymerization method, a solution polymerization method, and a melt polymerization method. The interfacial polymerization method is a polymerization method of mixing a divalent carboxylic acid halide dissolved in an organic solvent that is incompatible with water and dihydric alcohol dissolved in an alkali aqueous solution to obtain polyester. As literature regarding the interfacial polymerization method, W. M. EARECKSON, J. Poly. Sci., XL399 (1959), and Japanese Patent Publication No. Sho 40-1959, and the like may be cited. Since the interfacial polymerization method enables the reaction to proceed faster than the reaction carried out by the solution polymerization method and also enables suppression of hydrolysis of the divalent carboxylic acid halide, as a result, a high-molecular-weight polyarylate resin (PA) can be obtained.

### Polycarbonate Resin

As the polycarbonate resin, for example, a polycarbonate resin in which constitutional units having an aromatic ring are continuous is preferable. In the polycarbonate resin, resin molecules are bonded to each other by an intermolecular force due to stacking of aromatic rings, and thus the abrasion resistance of the charge transport layer is improved. Preferred forms of the polycarbonate resin include, specifically, the polycarbonate resin disclosed in JP2023-121553A.

In a case where the polyarylate resin (PA) and the polycarbonate resin are used in combination, as the combination of the polyarylate resin (PA) and the polycarbonate resin, for example, a combination of resins both having a constitutional unit containing biphenyl represented by Formula (BP) is preferable. That is, for example, it is preferable that each of the polyarylate resin and the polycarbonate resin has a constitutional unit containing biphenyl represented by Formula (BP).

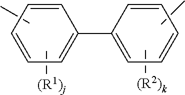

In Formula (BP), j is an integer of 0 or more and 4 or less, j pieces of R's are each independently a methyl group or an ethyl group, k is an integer of 0 or more and 4 or less, and k pieces of R²'s are each independently a methyl group or an ethyl group.

The biphenyl represented by Formula (BP) may be an entire structure or a part of a structure obtained by removing an ester bond (—C(═O)O—) or a carbonate bond (—OC(═O)O—) from the constitutional unit including the biphenyl represented by Formula (BP). In other words, the right end and the left end of the biphenyl represented by Formula (BP) may be each independently bonded to an ester bond or a carbonate bond directly or bonded to an ester bond or a carbonate bond via another atom or an atomic group.

j is an integer of 0 or more and 4 or less, for example, preferably an integer of 0 or more and 3 or less, more preferably an integer of 0 or more and 2 or less, still more preferably 0 or 1, and particularly preferably 0.

In a case where j is an integer of 1 or more, j pieces of R¹'s are each independently a methyl group or an ethyl group, and are preferably a methyl group.

k is an integer of 0 or more and 4 or less, for example, preferably an integer of 0 or more and 3 or less, more preferably an integer of 0 or more and 2 or less, still more preferably 0 or 1, and particularly preferably 0.

In a case where k is an integer of 1 or more, k pieces of R²'s are each independently a methyl group or an ethyl group and, for example, preferably a methyl group.

The biphenyl represented by Formula (BP) is, for example, preferably 4,4′-biphenyl with respect to a linking position in a main chain.

As a combination of the polyarylate resin and the polycarbonate resin, for example, a combination of a polyarylate resin having at least one of a dicarboxylic acid unit (A2-3) or a diol unit (B7-1) and a polycarbonate resin having a constitutional unit (Cb7-1) is particularly preferable.

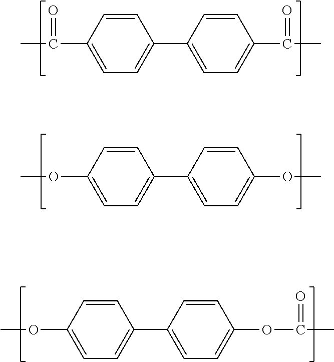

A blending ratio between the charge transport material and the binder resin is, for example, preferably 10:1 to 1:5 in terms of mass ratio.

The charge transport layer may also contain other known additives such as an antioxidant.

The formation of the charge transport layer is not particularly limited, and a known forming method in the related art is used. For example, a coating film of a coating solution for forming the charge transport layer, in which the above-described components are added to a solvent, is formed, and the coating film is dried and then heated as necessary.

Examples of the solvent for preparing the coating solution for forming the charge transport layer include typical organic solvents such as aromatic hydrocarbons such as benzene, toluene, xylene, and chlorobenzene; ketones such as acetone and 2-butanone; halogenated aliphatic hydrocarbons such as methylene chloride, chloroform, and ethylene chloride; and cyclic or linear ethers such as tetrahydrofuran and ethyl ether. The solvents are used alone or in a form of a mixture of two or more kinds thereof.

Examples of the coating method of coating the charge generation layer with the coating solution for forming the charge transport layer include typical methods such as a blade coating method, a wire bar coating method, a spray coating method, a dip coating method, a bead coating method, an air knife coating method, and a curtain coating method.

A film thickness of the charge transport layer is set to, for example, preferably in a range of 5 μm or more and 50 μm or less and more preferably in a range of 10 μm or more and 30 μm or less.

### Protective Layer

A protective layer is provided on the photosensitive layer as necessary. The protective layer is provided, for example, for the purpose of preventing a chemical change in the photosensitive layer during charging and further improving a mechanical strength of the photosensitive layer.

Therefore, for example, a layer formed of a cured film (crosslinked film) may be applied to the protective layer. Examples of the layer include layers described in the items 1) and 2) below.

The protective layer corresponds to the outermost surface layer, and thus contains the above-described silicone rubber particles.

1) A layer formed of a cured film with a composition containing a reactive group-containing charge transport material that has a reactive group and a charge-transporting skeleton in the same molecule (that is, a layer containing a polymer or a crosslinked body of the reactive group-containing charge transport material)

2) A layer formed of a cured film with a composition containing a non-reactive charge transport material and a reactive group-containing non-charge transport material that has a reactive group and does not have a charge-transporting skeleton (that is, a layer containing the non-reactive charge transport material, and a polymer or a crosslinked body of the reactive group-containing non-charge transport material)

Examples of the reactive group of the reactive group-containing charge transport material include known reactive groups such as a chain polymerizable group, an epoxy group, —OH, —OR [here, R represents an alkyl group], —NH₂, —SH, —COOH, and —SiR^{Q1}_{3-Qn}(OR^{Q2})_{Qn} [here, R^{Q1} represents a hydrogen atom, an alkyl group, or a substituted or unsubstituted aryl group, R^{Q2} represents a hydrogen atom, an alkyl group, or a trialkylsilyl group, and Qn represents an integer of 1 to 3].

The chain polymerizable group is not particularly limited as long as the group is a functional group capable of radical polymerization, and is, for example, a functional group having a group containing at least carbon double bond. Specific examples thereof include a vinyl group, a vinyl ether group, a vinyl thioether group, a styryl group (vinylphenyl group), an acryloyl group, a methacryloyl group, and a group containing at least one selected from derivatives thereof. Among the above, from the viewpoint that reactivity is excellent, for example, a vinyl group, a styryl group (vinylphenyl group), an acryloyl group, a methacryloyl group, or a group containing at least one selected from derivatives thereof is preferable as the chain polymerizable group.

The charge-transporting skeleton of the reactive group-containing charge transport material is not particularly limited as long as the skeleton is a known structure in the electrophotographic photoreceptor, and examples thereof include a structure conjugated with a nitrogen atom, which is a skeleton derived from a nitrogen-containing positive hole-transporting compound such as a triarylamine-based compound, a benzidine-based compound, and a hydrazone-based compound. Among the above, for example, a triarylamine skeleton is preferable.

The reactive group-containing charge transport material having the reactive group and the charge-transporting skeleton, the non-reactive charge transport material, and the reactive group-containing non-charge transport material may be selected from known materials.

Here, as the protective layer, for example, a layer composed of a cured film of a composition containing a reactive group-containing charge transport material having a reactive group and a charge-transporting skeleton in the identical molecule is suitable. That is, for example, it is preferable that the protective layer contains, as the binder resin, a polymer or a crosslinked body of the reactive group-containing charge transport material.

The polymer or crosslinked body of the reactive group-containing charge transport material may be a polymer or crosslinked body of the reactive group-containing charge transport material alone; or may be a polymer or crosslinked body of the reactive group-containing charge transport material and a reactive group-containing non-charge transport material.

As the reactive group-containing charge transport material, for example, at least one selected from the group consisting of a compound represented by Formula (RCT1) and a compound represented by Formula (RCT2) is suitable.

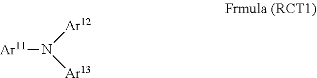

In Formula (RCT1), Ar¹¹ to Ar¹³ are each independently a substituted aryl group or an unsubstituted aryl group. A substituent that may be included in the substituted aryl group is an alkyl group having 1 or more and 6 or less carbon atoms, or a monovalent functional group represented by any one of Formulae (P-1) to (P-4). However, the compound represented by Formula (RCT1) has at least one monovalent functional group represented by any one of Formulae (P-1) to (P-4).

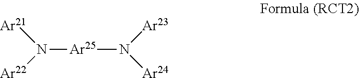

In Formula (RCT2), Ar²¹ to Ar²⁴ are each independently a substituted aryl group or an unsubstituted aryl group, and Ar²⁵ is a substituted arylene group or an unsubstituted arylene group. A substituent that may be included in the substituted aryl group is an alkyl group having 1 or more and 6 or less carbon atoms, or a monovalent functional group represented by Formulae (P-1) to (P-4). A substituent that may be included in the substituted arylene group is an alkyl group having 1 or more and 6 or less carbon atoms, or a monovalent functional group represented by Formulae (P-1) to (P-4). However, the compound represented by Formula (RCT2) has at least one monovalent functional group represented by any one of Formulae (P-1) to (P-4).

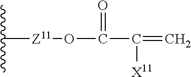

In Formula (P-1), Z¹¹ is a single bond or an alkylene group having 1 or more and 6 or less carbon atoms, and X¹¹ is a hydrogen atom or a methyl group.

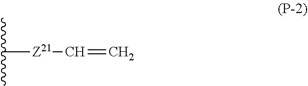

In Formula (P-2), Z²¹ is a single bond or an alkylene group having 1 or more and 6 or less carbon atoms.

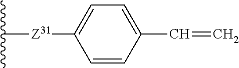

In Formula (P-3), Z³¹ is a single bond or an alkylene group having 1 or more and 6 or less carbon atoms.

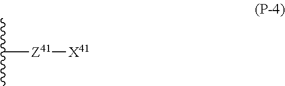

In Formula (P-4), Z⁴¹ is a single bond or an alkylene group having 1 or more and 6 or less carbon atoms, and X⁴¹ is a hydroxy group (—OH), an alkoxy group (—OR [where R represents an alkyl group]), an amino group (—NH₂), a thiol group (—SH), or a carboxyl group (—COOH).

Specific examples of the compound represented by (RCT1) and the compound represented by (RCT2) include, but are not limited to, compounds described in paragraphs 0139 to 0146 of JP2024-125151A, compounds described in paragraphs 0210 to 0272 of JP6592908B, compounds described in paragraphs 0094 to 0182 of JP4769848B, and compounds described in paragraphs 0061 to 0100 of JP2008-165248A.

The protective layer may also contain other known additives such as a crosslinking agent and an antioxidant.

The formation of the protective layer is not particularly limited, and a known forming method is used. For example, a coating film of a coating solution for forming the protective layer, in which the above-described components are added to a solvent, is formed, and the coating film is dried and then subjected to a curing treatment such as heating as necessary.

Examples of the solvent for preparing the coating solution for forming the protective layer include an aromatic solvent such as toluene and xylene; a ketone-based solvent such as methyl ethyl ketone, methyl isobutyl ketone, and cyclohexanone; an ester-based solvent such as ethyl acetate and butyl acetate; an ether-based solvent such as tetrahydrofuran and dioxane; a cellosolve-based solvent such as ethylene glycol monomethyl ether; and an alcohol-based solvent such as isopropyl alcohol and butanol. The solvents are used alone or in a form of a mixture of two or more kinds thereof.

The coating solution for forming the protective layer may be a solvent-less coating solution.

Examples of the method of coating the photosensitive layer (for example, the charge transport layer) with the coating solution for forming the protective layer include typical methods such as a dip coating method, a push-up coating method, a wire bar coating method, a spray coating method, a blade coating method, an air knife coating method, and a curtain coating method.

A film thickness of the protective layer is set to, for example, preferably in a range of 1 μm or more and 20 μm or less and more preferably in a range of 2 μm or more and 10 μm or less.

### Single Layer-Type Photosensitive Layer

A single layer-type photosensitive layer (charge generation layer or charge transport layer) is, for example, a layer containing a charge generation material, a charge transport material, and as necessary, a binder resin and other known additives. The materials are the same as the materials described in the sections of the charge generation layer and the charge transport layer.

A content of the charge generation material in the single layer-type photosensitive layer may be, for example, 0.1% by mass or more and 10% by mass or less, preferably 0.8% by mass or more and 5% by mass or less with respect to the total solid content. In addition, a content of the charge transport material in the single layer-type photosensitive layer may be, for example, 5% by mass or more and 50% by mass or less with respect to the total solid content.

The method of forming the single layer-type photosensitive layer is the same as the method of forming the charge generation layer or the charge transport layer.

A film thickness of the single layer-type photosensitive layer may be, for example, 5 m or more and 50 μm or less, preferably 10 μm or more and 40 μm or less.

### Image Forming Apparatus (and Process Cartridge)

The image forming apparatus according to the present exemplary embodiment includes the electrophotographic photoreceptor, a charging device that charges a surface of the electrophotographic photoreceptor, an electrostatic latent image forming device that forms an electrostatic latent image on the charged surface of the electrophotographic photoreceptor, a developing device that develops the electrostatic latent image formed on the surface of the electrophotographic photoreceptor with a developer containing a toner to form a toner image, and a transfer device that transfers the toner image to a surface of a recording medium. The above-described electrophotographic photoreceptor according to the present exemplary embodiment is adopted as the electrophotographic photoreceptor.

As the image forming apparatus according to the present exemplary embodiment, a known image forming apparatus such as an apparatus including a fixing device that fixes the toner image transferred to the surface of a recording medium; a direct transfer-type apparatus that transfers the toner image formed on the surface of the electrophotographic photoreceptor directly to the recording medium; an intermediate transfer-type apparatus that primarily transfers the toner image formed on the surface of the electrophotographic photoreceptor to a surface of an intermediate transfer member and secondarily transfers the toner image transferred to the surface of the intermediate transfer member to the surface of the recording medium; an apparatus including a cleaning device that cleans the surface of the electrophotographic photoreceptor after the transfer of the toner image and before the charging; an apparatus including a discharging device that discharges the surface of the electrophotographic photoreceptor by applying the discharge light after the transfer of the toner image and before the charging; or an apparatus including an electrophotographic photoreceptor heating member for increasing the temperature of the electrophotographic photoreceptor and decreasing the relative temperature is adopted.

In a case of the intermediate transfer-type apparatus, the transfer device has a configuration including an intermediate transfer member with surface on which the toner image will be transferred, a primary transfer device that performs primary transfer to transfer the toner image formed on the surface of the electrophotographic photoreceptor to the surface of the intermediate transfer member, and a secondary transfer device that performs secondary transfer to transfer the toner image transferred to the surface of the intermediate transfer member to the surface of a recording medium.

The image forming apparatus according to the present exemplary embodiment may be any of a dry development-type image forming apparatus or a wet development-type (development type using a liquid developer) image forming apparatus.

In the image forming apparatus according to the present exemplary embodiment, for example, a portion including the electrophotographic photoreceptor may have a cartridge structure (process cartridge) that is attachable to and detachable from the image forming apparatus. As the process cartridge, for example, a process cartridge including the electrophotographic photoreceptor according to the present exemplary embodiment is preferably used. The process cartridge may include, for example, at least one selected from the group consisting of a charging device, an electrostatic latent image forming device, a developing device, and a transfer device, in addition to the electrophotographic photoreceptor.

Hereinafter, an example of the image forming apparatus according to the present exemplary embodiment will be described, but the present exemplary embodiment is not limited thereto. Hereinafter, among the parts shown in the drawing, main parts will be described, and others will not be described.

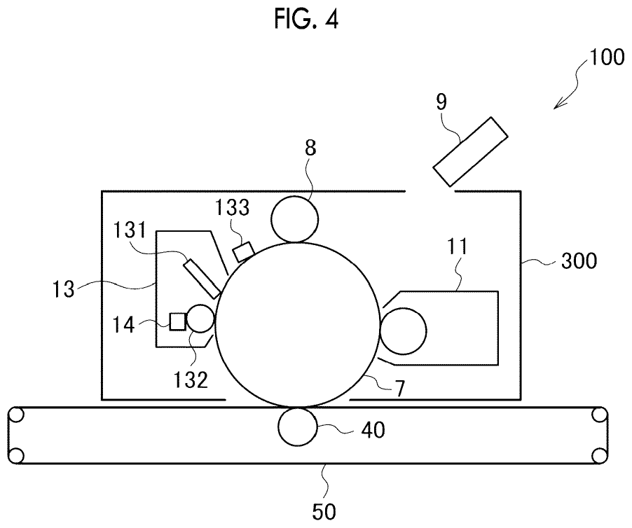

FIG. 4 is a view schematically showing a configuration of an example of the image forming apparatus according to the present exemplary embodiment.

As shown in FIG. 4, an image forming apparatus 100 according to the present exemplary embodiment includes a process cartridge 300 including an electrophotographic photoreceptor 7, an exposure device 9 (an example of the electrostatic latent image forming device), a transfer device 40 (primary transfer device), and an intermediate transfer member 50. In the image forming apparatus 100, the exposure device 9 is disposed at a position that can be exposed to the electrophotographic photoreceptor 7 from an opening portion of the process cartridge 300; the transfer device 40 is disposed at a position that faces the electrophotographic photoreceptor 7 through the intermediate transfer member 50; and the intermediate transfer member 50 is disposed such that a part of the intermediate transfer member 50 is in contact with the electrophotographic photoreceptor 7. Although not shown, the image forming apparatus also includes a secondary transfer device that transfers the toner image transferred to the intermediate transfer member 50 to a recording medium (for example, paper). The intermediate transfer member 50, the transfer device 40 (primary transfer device), and the secondary transfer device (not shown) correspond to an example of the transfer device.

The process cartridge 300 in FIG. 3 integrally supports the electrophotographic photoreceptor 7, a charging device 8 (an example of the charging device), a developing device 11 (an example of the developing device), and a cleaning device 13 (an example of the cleaning device) in a housing. The cleaning device 13 has a cleaning blade (an example of a cleaning member) 131, and the cleaning blade 131 is disposed to come into contact with the surface of the electrophotographic photoreceptor 7. The cleaning member may be a conductive or insulating fibrous member instead of the aspect of the cleaning blade 131, and may be used alone or in combination with the cleaning blade 131.

FIG. 4 shows an example of an image forming apparatus including a fibrous member 132 (roll shape) that supplies a lubricant 14 to the surface of the electrophotographic photoreceptor 7 and a fibrous member 133 (flat brush shape) that assists the cleaning, but these are disposed as necessary.

Hereinafter, each configuration of the image forming apparatus according to the present exemplary embodiment will be described.

### Charging Device

As the charging device 8, for example, a contact-type charger formed of a conductive or semi-conductive charging roller, a charging brush, a charging film, a charging rubber blade, a charging tube, or the like is used. Furthermore, known chargers such as a non-contact type roller charger, a scorotron charger using corona discharge, and a corotron charger are also used.

### Exposure Device

Examples of the exposure device 9 include an optical system device that exposes the surface of the electrophotographic photoreceptor 7 to light such as a semiconductor laser beam, LED light, and liquid crystal shutter light in a predetermined image pattern. A wavelength of the light source is within the spectral sensitivity region of the electrophotographic photoreceptor. As a wavelength of a semiconductor laser, near infrared laser, that has an oscillation wavelength in the vicinity of 780 nm, is mostly used. However, the wavelength is not limited thereto, and a laser having an oscillation wavelength of an approximately 600 nm level or a laser having an oscillation wavelength of 400 nm or more and 450 nm or less as a blue laser may also be used. Furthermore, a surface emission type laser light source capable of outputting a multi-beam is also effective for forming a color image.

### Developing Device

Examples of the developing device 11 include a typical developing device that performs development in contact or non-contact with the developer. The developing device 11 is not particularly limited as long as the device has the above-described functions, and is selected depending on the purpose thereof. Examples thereof include known developing machines having a function of attaching a one-component developer or a two-component developer to the electrophotographic photoreceptor 7 using a brush, a roller, or the like. Among the above, for example, a developing device formed of a developing roller having a surface on which a developer is held is preferably used.

The developer used in the developing device 11 may be a one-component developer containing only a toner or a two-component developer containing a toner and a carrier. In addition, the developer may be magnetic or non-magnetic. Known developers are employed as the developer.

### Cleaning Device

As the cleaning device 13, a cleaning blade-type device including the cleaning blade 131 is used.

In addition to the cleaning blade-type device, a fur brush cleaning-type device or a simultaneous development cleaning-type device may be adopted.

### Transfer Device

Examples of the transfer device 40 include transfer chargers known per se such as a contact-type transfer charger formed of a belt, a roller, a film, and a rubber blade, a scorotron transfer charger using corona discharge, and a corotron transfer charger.

### Intermediate Transfer Member

As the intermediate transfer member 50, a semi-conductive belt-like intermediate transfer member (intermediate transfer belt) containing polyimide, polyamide-imide, polycarbonate, polyarylate, polyester, rubber, or the like is used. In addition, as the form of the intermediate transfer member, a drum-like intermediate transfer member may be used in addition to the belt-like intermediate transfer member.

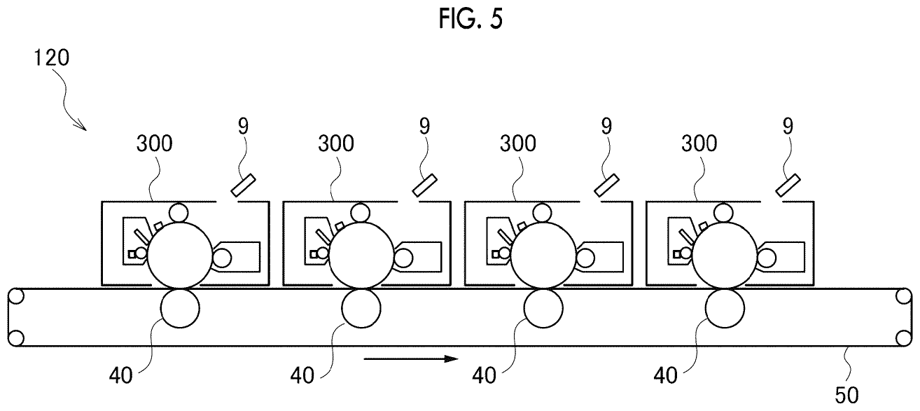

FIG. 5 is a view schematically showing a configuration of another example of the image forming apparatus according to the present exemplary embodiment.

An image forming apparatus 120 shown in FIG. 5 is a tandem type multicolor image forming apparatus in which four process cartridges 300 are mounted. The image forming apparatus 120 is formed such that the four process cartridges 300 are arranged in parallel on the intermediate transfer member 50, and one electrophotographic photoreceptor is used for each color. The image forming apparatus 120 has the same configuration as the image forming apparatus 100, except that the image forming apparatus 120 is of a tandem type.

### Functional Layer

The functional layer according to the present exemplary embodiment contains a binder resin and silicone rubber particles in which primary particles have a volume-average particle diameter of 0.01 μm or more and less than 3 μm.

With the above-described configuration, the functional layer according to the present exemplary embodiment is a functional layer excellent in abrasion resistance and lubricity. The reason is presumed to be as described for the photoreceptor according to the present exemplary embodiment.

Examples of a configuration of the functional layer according to the present exemplary embodiment include the same configurations as the charge transport layer, the single layer-type photosensitive layer, and the protective layer with regard to the outermost surface layer of the photoreceptor according to the present exemplary embodiment.

However, the functional layer according to the present exemplary embodiment does not need to contain materials specific to the photoreceptor, such as the charge transport material and the charge generation material, and a formulation thereof is selected according to the application.

The functional layer according to the present exemplary embodiment can be applied to uses such as members used for charging, developing, cleaning, intermediate transfer, fixing, and the like in an image forming apparatus. Specific examples of the form of the member include a roll shape, a belt shape, and a blade shape.

The functional layer according to the present exemplary embodiment can be applied, in addition to the image forming apparatus, to surface layers of various articles, such as packaging materials for foods and medicines, medical supplies (such as catheters and syringes), protective films and protective layers for electronic devices, textiles used for clothing and fabric products, home appliances, automobiles, and aircraft and space-related equipment, as well as to surface layers of parts for which friction reduction is required in rubbing or sliding portions of industrial machinery.

In addition, examples of uses of the functional layer according to the present exemplary embodiment, which contains the charge transport material or the charge generation material, include use as a surface layer of organic electronic devices such as organic electroluminescent elements, organic transistors, organic solar cells, and sensors, in addition to use for electrophotographic photoreceptors.

### EXAMPLES

Hereinafter, exemplary embodiments of the present invention will be specifically described based on examples. However, the exemplary embodiments of the present invention are not limited to the examples.

In the following description, unless otherwise specified, “parts” and “%” are based on mass.

In the following description, the synthesis, the production, the treatment, the measurement, and the like are carried out at room temperature (25° C.±3° C.), unless otherwise specified.

### Preparation of Charge Transport Material

The following charge transport materials are prepared.
Charge transport material CTM-1
Charge transport material CTM-2
Charge transport material ETM-1
Reactive charge transport material RCTM-A
Reactive charge transport material RCTM-B
Reactive charge transport material RCTM-C

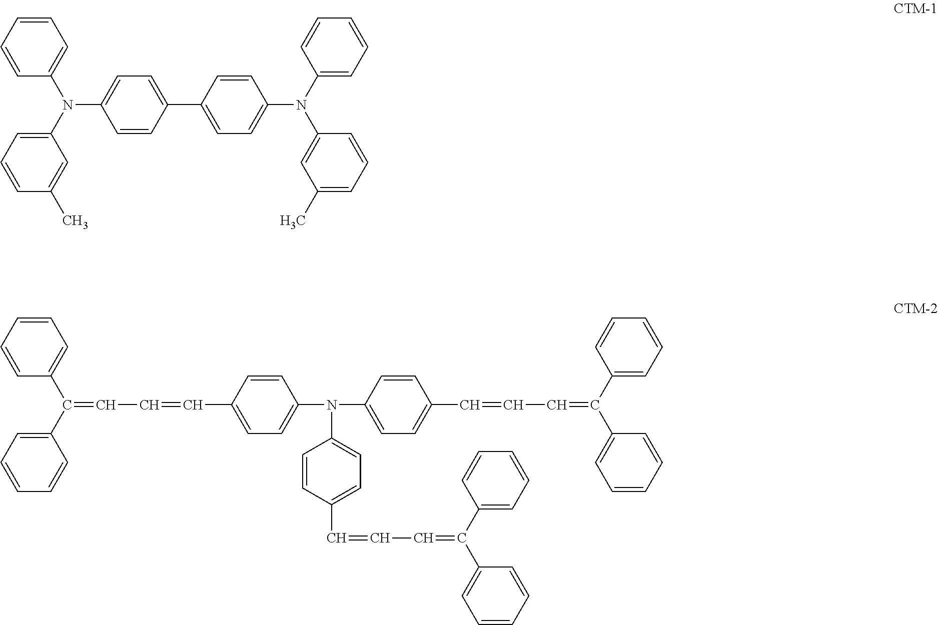 [SMILES: Cc1cccc(N(c2ccccc2)c2ccc(-c3ccc(N(c4ccccc4)c4cccc(C)c4)cc3)cc2)c1 ; C(=Cc1ccc(N(c2ccc(C=CC=C(c3ccccc3)c3ccccc3)cc2)c2ccc(C=CC=C(c3ccccc3)c3ccccc3)cc2)cc1)C=C(c1ccccc1)c1ccccc1]

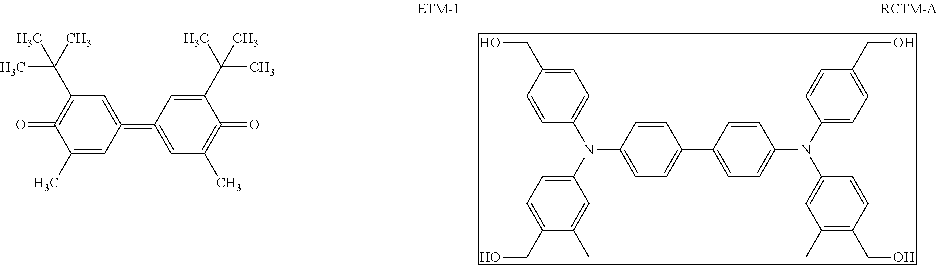

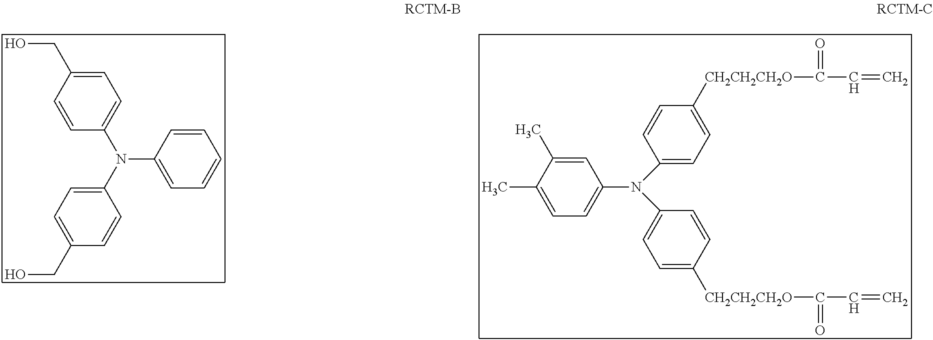

### Synthesis of Polyarylate Resin

Polyarylate resins (PAR-1) to (PAR-15) having the dicarboxylic acid unit (A) and the diol unit (B) shown in Table 1 below are prepared.

The table below shows the units constituting the polyarylate resin and the weight-average molecular weight (Mw).

A2-3 and the like described in Table 1 are specific examples of the aforementioned dicarboxylic acid unit (A).

B1-2 and the like described in Table 1 are specific examples of the aforementioned diol unit (B).

TABLE 1

| Polyarylate | Dicarboxylic acid unit (A) | | | | Diol unit (B) | | | | Mw |
|---|---|---|---|---|---|---|---|---|---|
| resin | No. | mol % | No. | mol % | No. | mol % | No. | mol % | k |
| PAR-1 | A2-3 | 50 | | | B1-4 | 50 | | | 105 |
| PAR-2 | A2-3 | 50 | | | B1-2 | 50 | | | 108 |
| PAR-3 | A2-3 | 50 | | | B2-6 | 50 | | | 110 |
| PAR-4 | A2-3 | 50 | | | B2-8 | 50 | | | 108 |
| PAR-5 | A2-3 | 50 | | | B5-1 | 50 | | | 107 |
| PAR-6 | A3-2 | 50 | | | B1-2 | 50 | | | 105 |
| PAR-7 | A3-2 | 40 | A4-3 | 10 | B6-4 | 50 | | | 101 |
| PAR-8 | A3-2 | 50 | | | B3-3 | 40 | B7-2 | 10 | 102 |
| PAR-9 | A3-2 | 50 | | | B4-4 | 50 | | | 105 |
| PAR-10 | A1-1 | 25 | A1-7 | 25 | B4-3 | 50 | | | 102 |
| PAR-11 | A1-1 | 25 | A1-7 | 25 | B3-3 | 50 | | | 103 |
| PAR-12 | A2-3 | 40 | A3-2 | 10 | B1-2 | 50 | | | 101 |
| PAR-13 | A2-3 | 40 | A4-3 | 10 | B5-4 | 50 | | | 101 |
| PAR-14 | A2-3 | 40 | A1-7 | 10 | B2-6 | 50 | | | 105 |
| PAR-15 | A2-3 | 50 | | | B2-10 | 50 | | | 109 |

### Preparation of Polycarbonate Resin

The following polycarbonate resins (PC-1) to (PC-3) are prepared.
Polycarbonate resin (PC-1) (viscosity-average molecular weight: 45,000)
Polycarbonate resin (PC-2) (viscosity-average molecular weight: 45,000)
Polycarbonate resin (PC-3) (viscosity-average molecular weight: 40,000)

Here, the numerical values in the formula indicate the molar ratio.

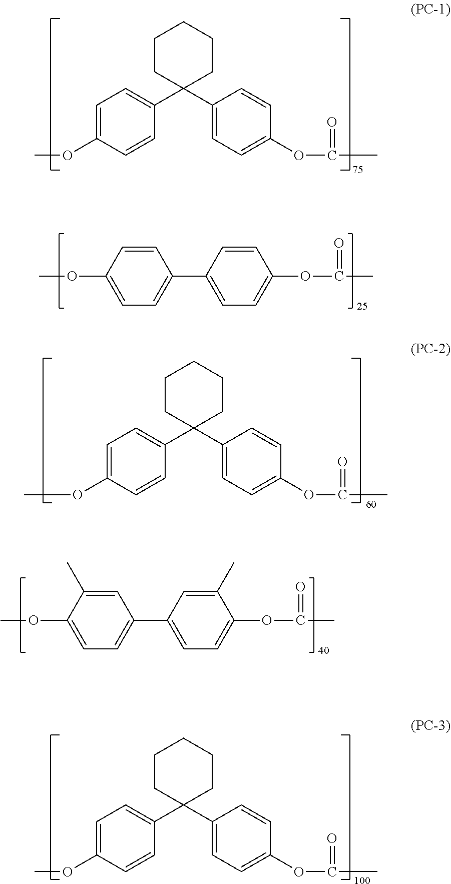

### Preparation of Silicone Rubber Particles or Silicone Rubber Resin Composite Particles

The following silicone rubber particles or silicone rubber resin composite particles are prepared.
KMP-597 (powder): silicone rubber particles (“KMP-597” manufactured by Shin-Etsu Chemical Co., Ltd.; volume-average particle diameter of primary particles=5.0 μm)
Crushed products A and B of KMP-597 (powder): crushed products obtained by crushing silicone rubber particles (“KMP-597” manufactured by Shin-Etsu Chemical Co., Ltd.) with a planetary mill to have a volume-average particle diameter of primary particles shown in Table 2 (denoted as “particle diameter” in Table 2)
KMP-9729 (emulsion): silicone rubber particles (“KMP-9729” manufactured by Shin-Etsu Chemical Co., Ltd.; volume-average particle diameter of primary particles=2 μm)
Classified products A and B of KMP-9729: classified products obtained by classifying silicone rubber particles (“KMP-9729” manufactured by Shin-Etsu Chemical Co., Ltd.) by the following classification method to have a volume-average particle diameter of primary particles shown in Table 2 (denoted as “particle diameter” in Table 2)
KMP-605 (powder): silicone rubber resin composite particles (“KMP-605” manufactured by Shin-Etsu Chemical Co., Ltd.; volume-average particle diameter of primary particles=2.0 μm)
Torayfil E500 (powder): silicone rubber particles (“Torayfil E500” manufactured by Dow Corning Toray Co., Ltd.; volume-average particle diameter of primary particles=3.0 μm)
Synthetic products A and B: silicone rubber particles obtained by the following synthesis method

### Classification Method

Centrifugation of KMP-9729 (emulsion) is repeated until a target particle diameter is obtained. The particle diameter is checked each time with a Beckman Coulter particle size analyzer. The supernatant liquid in the lower layer after the centrifugation is fractionated to obtain an aqueous dispersion. The classified products A and B are obtained by freeze-drying the obtained aqueous dispersion. The particles after freeze-drying are observed with an electron microscope to confirm that the target particle diameter is obtained.

### Synthesis Method of Silicone Rubber Particles

250 g of methylvinylpolysiloxane having a kinematic viscosity of 130 mm²/s, represented by Formula (S1),

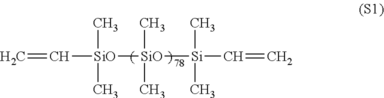

250 g of methylvinylpolysiloxane having a kinematic viscosity of 600 mm²/s, represented by Formula (S2),

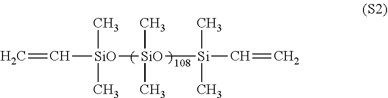

and 32 g of methylhydrogenpolysiloxane having a kinematic viscosity of 30 mm²/s, represented by Formula (S3) (an amount such that the number of hydrosilyl groups is 1.11 per one olefinic unsaturated group in the compounds represented by Formulas (S1) and (S2))

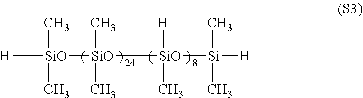

are charged into a 1 L glass beaker and dissolved by stirring at 2,000 rpm using a homomixer.

Next, 3 g of polyoxyethylene stearyl ether having an ethylene oxide (hereinafter abbreviated as EO) with an addition mole number of 15 mol (trade name manufactured by Nihon Emulsion Co., Ltd.: Emulgen 615, HLB=14.3) and 50 g of water are added thereto, and by stirring at 8,000 rpm using a homomixer, the mixture becomes an oil-in-water type and thickening is observed. The stirring is continued for another 15 minutes. Next, while stirring at 2,000 rpm, 413 g of water is added thereto to obtain a uniform white emulsion.

The above-described emulsion is transferred to a 1 L glass flask equipped with a stirrer having an anchor-type stirring blade, and after adjusting the temperature to 15° C. to 20° C., a mixed solution of 0.8 g of an isododecane solution of a chloroplatinic acid-olefin complex (platinum content 0.5%) and polyoxyethylene sorbitan tristearate having an EO addition mole number=20 mol (trade name manufactured by Nikko Chemicals Co., Ltd.: NIKKOL TS-30V) 1 g is added thereto under stirring, and stirred at the same temperature for 12 hours to obtain an aqueous dispersion of silicone rubber particles (hereinafter, referred to as an aqueous dispersion-1).

Centrifugation of the above-described aqueous dispersion-1 is repeated until the target particle diameter is obtained. The particle diameter is checked each time with a Beckman Coulter particle size analyzer. The supernatant liquid in the lower layer after the centrifugation is fractionated to obtain an aqueous dispersion. The particle diameter is checked each time with a Beckman Coulter particle size analyzer. The particles after freeze-drying are observed with an electron microscope to confirm that the target particle diameter is obtained.

### Example 1: Laminated Type Photoreceptor

### Formation of Undercoat Layer

### Example 1: Laminated Type Photoreceptor

### Formation of Undercoat Layer

3.5 parts of a butyral resin (trade name: ESLEC BM-1, manufactured by Sekisui Chemical Co., Ltd.) and 41 parts of methyl ethyl ketone are mixed and dissolved. After adding and stirring 10 parts of a curing agent (blocked isocyanate; trade name: Sumidur 3175, Sumitomo Bayer Urethane Co., Ltd.), 45.5 parts of zinc oxide (trade name: SMZ-017N, TAYCA Corporation) surface-treated with a silane coupling agent (trade name: KBM603, Shin-Etsu Chemical Co., Ltd.), and 0.27 parts of the following compound, the mixture is dispersed for 2 hours using a sand mill with 1-mm-diameter glass beads. Further, 0.01 parts of dioctyltin dilaurate and 2 parts of silicone resin particles (trade name: TOSPEARL 145, GE Toshiba Silicone Co., Ltd.) are added thereto and stirred to obtain a coating solution for forming an undercoat layer. The coating solution for forming an undercoat layer is applied to an outer peripheral surface of the conductive substrate by dip coating, and dried and cured at 170° C. for 40 minutes to form an undercoat layer having a layer thickness of 20 μm.

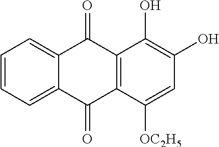 [SMILES: CCOc1cc(O)c(O)c2c1C(=O)c1ccccc1C2=O]

### Formation of Charge Generation Layer

A mixture containing 15 parts of hydroxygallium phthalocyanine as a charge generation substance (having diffraction peaks at Bragg angles (2θ+0.2θ) of at least 7.5°, 9.9°, 12.5°, 16.3°, 18.6°, 25.1°, and 28.3° in an X-ray diffraction spectrum obtained using CuKα characteristic X-rays), 10 parts of a vinyl chloride-vinyl acetate copolymer resin as a binder resin (trade name: VMCH, manufactured by Nippon Unicar Company Limited), and 200 parts of n-butyl acetate is dispersed for 4 hours in a sand mill using glass beads having a diameter of 1 mm. 175 parts of n-butyl acetate and 180 parts of methyl ethyl ketone are added to the dispersion, and the mixture is stirred to obtain a coating solution for forming a charge generation layer. The coating solution for forming a charge generation layer is dip-coated on the undercoat layer, and dried at room temperature to form a charge generation layer having an average thickness of 0.25 μm.

### Formation of Charge Transport Layer (CTL)

| | |
|---|---|
| Binder resin: polycarbonate resin (PC-1) | 60 parts |
| Charge transport material: CTM-1 | 28 parts |
| Charge transport material: CTM-2 | 12 parts |
| Particles: crushed product A of KMP-597 | 5.3 parts |

(5% by mass with respect to the charge transport layer)

The above-described materials are dissolved or dispersed in a mixed solvent of 550 parts of tetrahydrofuran and 50 parts of toluene to obtain a coating solution for forming a charge transport layer. The coating solution for forming a charge transport layer is dip-coated on the charge generation layer, and dried at a temperature of 150° C. for 40 minutes to form a charge transport layer having an average thickness of 32 μm.

A photoreceptor of Example 1 is obtained through the above-described operations.

### Examples 2 to 18, Examples 24 to 31, and Comparative Example 1 to 5: Laminated Type Photoreceptor

Photoreceptors of each of Examples are obtained in the same manner as in Example 1, except that the following items are changed.
Type of binder resin
Type and content of particles

### Examples 19 to 21: Laminated Type Photoreceptor

Photoreceptors of each of Examples are obtained in the same manner as in Example 1, except that the charge transport layer is formed as follows.

| | |
|---|---|
| Charge transport material: CTM-1 | 71 parts |
| Resin: polyarylate resin (PAR-2) | 28 parts (30% of |
| | total resin) |
| Resin: polycarbonate resin (PC1) | 66 parts (70% of |
| | total resin) |
| Particles: crushed product A of KMP-597 | 8.70 parts |

(5% by mass with respect to the charge transport layer)

The above-described materials are dissolved or dispersed in a mixed solvent of 570 parts of tetrahydrofuran and 57 parts of toluene to obtain a coating solution for forming a charge transport layer. The coating solution for forming a charge transport layer is dip-coated on the charge generation layer, and dried at a temperature of 150° C. for 40 minutes to form a charge transport layer having an average thickness of 32 μm.

### Example 22: Photoreceptor 1 with Protective Layer

In the same manner as in Example 1, an undercoat layer and a charge generation layer are formed on a conductive substrate.

### Formation of Charge Transport Layer

### Formation of Charge Transport Layer (CTL)

| | |
|---|---|
| Binder resin: polycarbonate resin (PC-3) | 55 parts |
| Charge transport material: CTM-1 | 45 parts |

The above-described materials are dissolved or dispersed in a mixed solvent of 550 parts of tetrahydrofuran and 50 parts of toluene to obtain a coating solution for forming a charge transport layer. The coating solution for forming a charge transport layer is dip-coated on the charge generation layer, and dried at a temperature of 110° C. for 30 minutes to form a charge transport layer having an average thickness of 20 μm.

### Formation of Protective Layer (OC)

| | | |
|---|---|---|
| Reactive charge transport material: RCTM-A | 70 | parts |
| Reactive charge transport material: RCTM-B | 50 | parts |
| Reactive group-containing non-charge transport | 5 | parts |
| material: benzoguanamine resin (trade name: | | |
| NIKALAC BL-60, Sanwa Chemical Co., Ltd.) | | |
| Curing catalyst: NACURE 5225 (King Industries) | 0.3 | parts |
| Solvent: 2-propanol | 150 | parts |
| Particles: crushed product A of KMP-597 | 6.5 | parts |

(5% by mass with respect to the protective layer)

The above-described materials are mixed to obtain a coating solution for forming a protective layer. The coating solution for forming a protective layer is dip-coated on the charge transport layer, placed in a heating furnace, and heat-treated at a temperature of 150° C. for 40 minutes to cure the dry film, thereby forming a protective layer having a film thickness of 7.0 μm.

A photoreceptor of Example 22 is obtained through the above-described operations.

### Example 23: Photoreceptor with Protective Layer

In the same manner as in Example 22, an undercoat layer and a charge generation layer are formed on a conductive substrate.

Formation of Charge Transport Layer
Formation of Charge Transport Layer (CTL)

| | |
|---|---|
| Binder resin: polycarbonate resin (PC-3) | 55 parts |
| Charge transport material: CTM-1 | 45 parts |

The above-described materials are dissolved or dispersed in a mixed solvent of 550 parts of tetrahydrofuran and 50 parts of toluene to obtain a coating solution for forming a charge transport layer. The coating solution for forming a charge transport layer is dip-coated on the charge generation layer, and dried at a temperature of 110° C. for 30 minutes to form a charge transport layer having an average thickness of 20 μm.

### Formation of Protective Layer (OC)

Reactive charge transport material: RCTM-C . . . 75 parts
Reactive group-containing non-charge transport material: tris(2-acryloyloxyethyl) isocyanurate (trade name: T-2325, manufactured by Tokyo Chemical Industry Co., Ltd.) . . . 22 parts

| | |
|---|---|
| Solvent: 2-propanol | 100 parts |
| Particles: crushed product A of KMP-597 | 5.1 parts |

(5% by mass with respect to the protective layer)

The above-described materials are mixed to obtain a coating solution for forming a protective layer. The coating solution for forming a protective layer is dip-coated on the charge transport layer and dried at 40° C. for 5 minutes. Next, the coating film is irradiated with an electron beam for 2.0 seconds under conditions of an acceleration voltage of 70 kV and an absorbed amount of 15 kGy in a nitrogen atmosphere. Further, in a nitrogen atmosphere, the coating film is heated for 18 seconds at a coating film temperature of 135° C., allowed to cool naturally until the coating film reaches 25° C., and then heated for 1 hour at a coating film temperature of 120° C., thereby forming a protective layer having a film thickness of 7.0 μm.

A photoreceptor of Example 23 is obtained through the above-described operations.

### Comparative Example 6 to 10: Photoreceptor with Protective Layer

Photoreceptors are obtained in the same manner as in Example 22, except that the type and amount of particles are changed.

### Example 32: Laminated Type Photoreceptor

### Formation of Single Layer-Type Photosensitive Layer (SPL)

| | | |
|---|---|---|
| Binder resin: polyarylate resin (PAR-2) | 45 | parts |
| Charge generation material: V-type hydroxygallium | 1.0 | part |
| phthalocyanine (having diffraction peaks at | | |
| positions where Bragg angles (2θ ± 0.2°) of | | |
| an X-ray diffraction spectrum using CuKα | | |
| characteristic X-rays are at least | | |
| 7.3°, 16.0°, 24.9°, and 28.0°) | | |
| Charge transport material: ETM-1 | 9 | parts |
| Charge transport material: CTM-1 | 45 | parts |
| Particles: crushed product A of KMP-597 | 2.9 | parts |

(5% by mass with respect to the single-layer photosensitive layer)

The above-described materials are dissolved or dispersed in a mixed solvent of 175 parts of tetrahydrofuran and 75 parts of toluene, and dispersed in a sand mill using glass beads having a diameter of 1 mm for 4 hours to obtain a coating solution for forming a photosensitive layer. The coating solution for forming a photosensitive layer is applied to an outer peripheral surface of a conductive substrate (aluminum cylindrical tube having an outer diameter of 30 mm, a length of 365 mm, and a wall thickness of 1.6 mm) by a dip coating method, and dried at a temperature of 150° C. for 60 minutes to form a single layer-type photosensitive layer having an average thickness of 36 μm.

A photoreceptor of Example 32 is obtained through the above-described operations.

### Evaluation

The following evaluations are performed on the photoreceptor of each example.

### Abrasion Resistance

The photoreceptor of each example is attached to ApeosPort Print C-5570 manufactured by Fujifilm Business Innovation Corp. to obtain an image forming apparatus.

Under a low temperature and low humidity environment (10° C. and 15%), an image having an image density of 5% is output on 100,000 sheets of A4 paper using the above-described image forming apparatus.

Before and after image formation, an average thickness (nm) of the outermost surface layer (charge transport layer, single layer-type photosensitive layer, or protective layer) is determined, and a difference between the worn portion and the non-worn portion is defined as the abrasion amount. Permascope manufactured by Fischer Scope is used as a film thickness measuring instrument. The abrasion amount is evaluated according to the following standard.

### Standard

5: abrasion amount is less than 2,500 nm.
4: abrasion amount is 2,500 nm or more and less than 5,000 nm.
3: abrasion amount is 5,000 nm or more and less than 10,000 nm.
2: abrasion amount is 10,000 nm or more and less than 15,000 nm.
1: abrasion amount is 15,000 nm or more.

### Cleanability

The photoreceptor of each example is attached to ApeosPort C-7070 manufactured by Fujifilm Business Innovation Corp. to obtain an image forming apparatus.

Under a high-temperature and high-humidity environment (30° C. and 85%), an image having an image density of 1% is output on 40,000 sheets of A4 paper using the above-described image forming apparatus. The last image after output is visually observed and evaluated according to the following standard.

### Standard

5: external additive filming does not occur.
4: external additive filming occurs slightly (level sufficiently acceptable in practical use).
3: external additive filming occurs (level acceptable in practical use).
2: external additive filming occurs (level unacceptable in practical use).
1: external additive filming occurs frequently (level unacceptable in practical use).

The “external additive filming” refers to a phenomenon in which an external additive of toner adheres to and becomes fixed on the photoreceptor.

### Crack Resistance

After standing for 24 hours under a high-temperature and high-humidity environment (45° C. and 95%), the photoreceptor is further left for 72 hours under a low-temperature and low-humidity environment (−5° C. and 15%). The environment is a condition that reproduces stress during transportation and storage of the photoreceptor. Thereafter, the photoreceptor is removed from the cartridge, and the crack occurrence state of the photoreceptor is observed using a microscope. Thereafter, the photoreceptor is reattached to the cartridge, a halftone image is output, and the image is visually observed and evaluated according to the following standard.

### Standard

5: no cracks are observed in the outermost surface layer of the photoreceptor, and there is no adverse effect on image quality.
4: cracks are observed only in a very small portion of the outermost surface layer of the photoreceptor, and there is no adverse effect on image quality.
3: although the number of cracks is small, cracks are observed over the entire surface of the outermost surface layer of the photoreceptor, and there is no adverse effect on image quality.
2: cracks are observed over the entire surface of the outermost surface layer of the photoreceptor, and there is no adverse effect on image quality.
1: cracks are observed over the entire surface of the outermost surface layer of the photoreceptor, and image quality is unacceptable in practical use.

### Lubricity

The lubricity of the outermost surface layer in the photoreceptor of each example is measured by a load fluctuation type friction and wear system (manufactured by Shinto Scientific Co., Ltd.: HHS2000) in a constant load reciprocating measurement mode (moving speed 10 mm/sec, vertical load 40 g, measurement distance 10 mm).

The number of reciprocations is 250, and the average value between 2 mm and 8 mm for each of the forward and backward paths is taken as the value of the friction coefficient. From the obtained value of the friction coefficient, grade evaluation is performed according to the following standard. The evaluation is also an evaluation as a functional layer.

### Standard

4: friction coefficient value is less than 0.4 over 1 and 250 reciprocations.
3: friction coefficient value is less than 0.6 over 1 and 250 reciprocations.
2: friction coefficient value is less than 0.8 over 1 and 250 reciprocations.
1: friction coefficient value is 0.8 or more over 1 and 250 reciprocations.

TABLE 2-1

Formation of outermost surface layer

Binder resin

| | | | | | | | | Mixing | |
|---|---|---|---|---|---|---|---|---|---|
| | | Particles | | | | | | ratio of | |
| | | | | Particle | Amount | | | resins | Corre- |
| | | Type of | | diameter | (% by | | | (mass | sponding |
| | | particles | Model | (μm) | mass) | Type of resin | | ratio) | layer |
| Example | 1 | Silicone rubber | Crushed product A | 2 | 5 | PC | PC-1 | — | CTL |
| | | particles | of KMP-597 | | | | | | |
| | | | (powder) | | | | | | |
| | 2 | Silicone rubber | Crushed product A | 2 | 5 | PC | PC-2 | — | CTL |
| | | particles | of KMP-597 | | | | | | |
| | | | (powder) | | | | | | |
| | 3 | Silicone rubber | Crushed product A | 2 | 5 | PC | PC-3 | — | CTL |
| | | particles | of KMP-597 | | | | | | |
| | | | (powder) | | | | | | |
| | 4 | Silicone rubber | Crushed product A | 2 | 5 | PAR | PAR-1 | — | CTL |
| | | particles | of KMP-597 | | | | | | |
| | | | (powder) | | | | | | |
| | 5 | Silicone rubber | Crushed product A | 2 | 5 | PAR | PAR-2 | — | CTL |
| | | particles | of KMP-597 | | | | | | |
| | | | (powder) | | | | | | |
| | 6 | Silicone rubber | Crushed product A | 2 | 5 | PAR | PAR-3 | — | CTL |
| | | particles | of KMP-597 | | | | | | |
| | | | (powder) | | | | | | |
| | 7 | Silicone rubber | Crushed product A | 2 | 5 | PAR | PAR-4 | — | CTL |
| | | particles | of KMP-597 | | | | | | |
| | | | (powder) | | | | | | |
| | 8 | Silicone rubber | Crushed product A | 2 | 5 | PAR | PAR-5 | — | CTL |
| | | particles | of KMP-597 | | | | | | |
| | | | (powder) | | | | | | |
| | 9 | Silicone rubber | Crushed product A | 2 | 5 | PAR | PAR-6 | — | CTL |
| | | particles | of KMP-597 | | | | | | |
| | | | (powder) | | | | | | |
| | 10 | Silicone rubber | Crushed product A | 2 | 5 | PAR | PAR-7 | — | CTL |
| | | particles | of KMP-597 | | | | | | |
| | | | (powder) | | | | | | |
| | 11 | Silicone rubber | Crushed product A | 2 | 5 | PAR | PAR-8 | — | CTL |
| | | particles | of KMP-597 | | | | | | |
| | | | (powder) | | | | | | |
| | 12 | Silicone rubber | Crushed product A | 2 | 5 | PAR | PAR-9 | — | CTL |
| | | particles | of KMP-597 | | | | | | |
| | | | (powder) | | | | | | |
| | 13 | Silicone rubber | Crushed product A | 2 | 5 | PAR | PAR-10 | — | CTL |
| | | particles | of KMP-597 | | | | | | |
| | | | (powder) | | | | | | |
| | 14 | Silicone rubber | Crushed product A | 2 | 5 | PAR | PAR-11 | — | CTL |
| | | particles | of KMP-597 | | | | | | |
| | | | (powder) | | | | | | |
| | 15 | Silicone rubber | Crushed product A | 2 | 5 | PAR | PAR-12 | — | CTL |
| | | particles | of KMP-597 | | | | | | |
| | | | (powder) | | | | | | |
| | 16 | Silicone rubber | Crushed product A | 2 | 5 | PAR | PAR-13 | — | CTL |
| | | particles | of KMP-597 | | | | | | |
| | | | (powder) | | | | | | |
| | 17 | Silicone rubber | Crushed product A | 2 | 5 | PAR | PAR-14 | — | CTL |
| | | particles | of KMP-597 | | | | | | |
| | | | (powder) | | | | | | |
| | 18 | Silicone rubber | Crushed product A | 2 | 5 | PAR | PAR-15 | — | CTL |
| | | particles | of KMP-597 | | | | | | |
| | | | (powder) | | | | | | |
| | 19 | Silicone rubber | Crushed product A | 2 | 5 | Mixing | PAR-2/ | 50/50 | CTL |
| | | particles | of KMP-597 | | | | PC-1 | | |
| | | | (powder) | | | | | | |
| | 20 | Silicone rubber | Crushed product A | 2 | 5 | Mixing | PAR-2/ | 60/40 | CTL |
| | | particles | of KMP-597 | | | | PC-1 | | |
| | | | (powder) | | | | | | |
| | 21 | Silicone rubber | Crushed product A | 2 | 5 | Mixing | PAR-2/ | 30/70 | CTL |
| | | particles | of KMP-597 | | | | PC-1 | | |
| | | | (powder) | | | | | | |
| | 22 | Silicone rubber | Crushed product A | 2 | 5 | RCTM | RCTM- | — | OC |
| | | particles | of KMP-597 | | | | A&B | | |
| | | | (powder) | | | | | | |
| | 23 | Silicone rubber | Crushed product A | 2 | 5 | RCTM | RCTM-C | — | OC |
| | | particles | of KMP-597 | | | | | | |
| | | | (powder) | | | | | | |

| | | Evaluation result | | | |
|---|---|---|---|---|---|
| | | Perfor- | Perfor- | Perfor- | |
| | | mance A | mance C | mance E | Perfor- |
| | | (abrasion | (clean- | (crack | mance D |
| | | resistance) | ability) | resistance) | (lubricity) |
| Example | 1 | 4 | 5 | 1 | 4 |
| | 2 | 4 | 5 | 4 | 4 |
| | 3 | 3 | 5 | 4 | 4 |
| | 4 | 5 | 4 | 4 | 4 |
| | 5 | 5 | 4 | 4 | 4 |
| | 6 | 5 | 4 | 4 | 4 |
| | 7 | 5 | 4 | 4 | 4 |
| | 8 | 5 | 4 | 4 | 4 |
| | 9 | 4 | 4 | 4 | 4 |
| | 10 | 4 | 4 | 4 | 4 |
| | 11 | 4 | 4 | 4 | 4 |
| | 12 | 4 | 4 | 4 | 4 |
| | 13 | 3 | 4 | 4 | 4 |
| | 14 | 3 | 4 | 4 | 4 |
| | 15 | 4 | 4 | 4 | 4 |
| | 16 | 3 | 4 | 4 | 4 |
| | 17 | 4 | 4 | 4 | 4 |
| | 18 | 5 | 4 | 4 | 4 |
| | 19 | 4 | 5 | 4 | 4 |
| | 20 | 4 | 5 | 4 | 4 |
| | 21 | 4 | 5 | 4 | 4 |
| | 22 | 5 | 4 | 4 | 4 |
| | 23 | 5 | 4 | 4 | 4 |

TABLE 2-2

Formation of outermost surface layer

Binder resin

| | | | | | | | | Mixing | |
|---|---|---|---|---|---|---|---|---|---|
| | | Particles | | | | | | ratio of | |
| | | | | Particle | Amount | | | resins | Corre- |
| | | Type of | | diameter | (% by | | | (mass | sponding |
| | | particles | Model | (μm) | mass) | Type of resin | | ratio) | layer |
| Example | 24 | Silicone rubber | Classified product A | 0.2 | 5 | PAR | PAR-2 | — | CTL |
| | | particles | of KMP-9729 | | | | | | |
| | 25 | Silicone rubber | Synthetic product A | 0.2 | 5 | PAR | PAR-2 | — | CTL |
| | | particles | | | | | | | |
| | 26 | Silicone rubber | Synthetic product B | 0.8 | 5 | PAR | PAR-2 | — | CTL |
| | | particles | | | | | | | |
| | 27 | Silicone rubber | Crushed product B | 2.8 | 5 | PAR | PAR-2 | — | CTL |
| | | particles | of KMP-597 (powder) | | | | | | |
| | 28 | Silicone rubber | Crushed product A | 2 | 0.5 | PAR | PAR-2 | — | CTL |
| | | particles | of KMP-597 (powder) | | | | | | |
| | 29 | Silicone rubber | Crushed product A | 2 | 1 | PAR | PAR-2 | — | CTL |
| | | particles | of KMP-597 (powder) | | | | | | |
| | 30 | Silicone rubber | Crushed product A | 2 | 15 | PAR | PAR-2 | — | CTL |
| | | particles | of KMP-597 (powder) | | | | | | |
| | 31 | Silicone rubber | Crushed product A | 2 | 25 | PAR | PAR-2 | — | CTL |
| | | particles | of KMP-597 (powder) | | | | | | |
| | 32 | Silicone rubber | Crushed product A | 2 | 5 | PAR | PAR-2 | — | SPL |
| | | particles | of KMP-597 (powder) | | | | | | |
| Comparative | 1 | No particles | — | — | 5 | PAR | PAR-2 | — | CTL |
| Example | 2 | Silicone rubber | Torayfil E500 | 3 | 5 | PAR | PAR-2 | — | CTL |
| | | particles | | | | | | | |
| | 3 | Silicone rubber | KMP-597 | 5 | 5 | PAR | PAR-1 | — | CTL |
| | | particles | | | | | | | |
| | 4 | Silicone rubber resin | KMP-605 | 2 | 5 | PAR | PAR-1 | — | CTL |
| | | composite particles | | | | | | | |
| | 5 | Silicone rubber | Classified product B | 0.008 | 5 | PAR | PAR-2 | — | CTL |
| | | particles | of KMP-9729 | | | | | | |
| | 6 | No particles | | — | 5 | RCTM | RCTM- | — | OC |
| | | | | | | | A&B | | |
| | 7 | Silicone rubber | Torayfil E500 | 3 | 5 | RCTM | RCTM- | — | OC |
| | | particles | | | | | A&B | | |
| | 8 | Silicone rubber | KMP-597 | 5 | 5 | RCTM | RCTM- | — | OC |
| | | particles | | | | | A&B | | |
| | 9 | Silicone rubber resin | KMP-605 | 2 | 5 | RCTM | RCTM- | — | OC |
| | | composite particles | | | | | A&B | | |
| | 10 | Silicone rubber | Classified product B | 0.008 | 5 | RCTM | RCTM- | — | OC |
| | | particles | of KMP-9729 | | | | A&B | | |

| | | Evaluation result | | | |
|---|---|---|---|---|---|
| | | Perfor- | Perfor- | Perfor- | |
| | | mance A | mance C | mance E | Perfor- |
| | | (abrasion | (clean- | (crack | mance D |
| | | resistance) | ability) | resistance) | (lubricity) |
| Example | 24 | 5 | 5 | 5 | 4 |
| | 25 | 5 | 5 | 5 | 4 |
| | 26 | 5 | 5 | 4 | 4 |
| | 27 | 5 | 4 | 2 | 4 |
| | 28 | 3 | 3 | 5 | 3 |
| | 29 | 3 | 3 | 4 | 3 |
| | 30 | 5 | 5 | 3 | 4 |
| | 31 | 5 | 5 | 2 | 4 |
| | 32 | 4 | 4 | 4 | 4 |
| Comparative | 1 | 1 | 1 | 5 | 1 |
| Example | 2 | 5 | 2 | 1 | 2 |
| | 3 | 5 | 2 | 1 | 2 |
| | 4 | 3 | 1 | 3 | 2 |
| | 5 | 5 | 2 | 4 | 2 |
| | 6 | 2 | 1 | 5 | 1 |
| | 7 | 5 | 2 | 1 | 2 |
| | 8 | 5 | 2 | 1 | 2 |
| | 9 | 4 | 1 | 3 | 2 |
| | 10 | 5 | 2 | 4 | 2 |

From the above-described results, it is found that the photoreceptor of the present example has improved abrasion resistance and crack resistance as compared with the photoreceptor of the comparative example.

It can also be found that the photoreceptor of the present example has improved cleanability and lubricity of the outermost surface layer.

It can also be found that the outermost surface layer of the photoreceptor of the present example is useful as a functional layer excellent in abrasion resistance and lubricity (particularly, a charge transport layer or a protective layer excellent in abrasion resistance, cleanability, crack resistance, and lubricity).

The present exemplary embodiment includes the following aspects. Each formula is the same as the formula having the same number described above.

(((1)))

An electrophotographic photoreceptor comprising:
a conductive substrate; and
a photosensitive layer disposed on the conductive substrate,
wherein an outermost surface layer contains a binder resin and silicone rubber particles in which primary particles have a volume-average particle diameter of 0.01 μm or more and less than 3 μm.
   (((2)))

The electrophotographic photoreceptor according to (((1))), wherein the outermost surface layer contains aggregated particles of the silicone rubber particles.

(((3)))

The electrophotographic photoreceptor according to (((1))) or (((2))), in which a content of the silicone rubber particles is 0.5% by mass or more and 25% by mass or less with respect to the outermost surface layer.

(((4)))

The electrophotographic photoreceptor according to any one of (((1))) to (((3))), wherein the outermost surface layer contains, as the binder resin, at least one of a polyarylate resin or a polycarbonate resin.

(((5)))

The electrophotographic photoreceptor according to any one of (((1))) to (((4))), wherein the outermost surface layer contains, as the binder resin, a polyarylate resin having a dicarboxylic acid unit (A) represented by Formula (A) and a diol unit (B) represented by Formula (B),

(((6)))

The electrophotographic photoreceptor according to (((5))), wherein the dicarboxylic acid unit (A) represented by Formula (A) includes at least one selected from the group consisting of a dicarboxylic acid unit (A1) represented by Formula (A1), a dicarboxylic acid unit (A2) represented by Formula (A2), a dicarboxylic acid unit (A3) represented by Formula (A3), a dicarboxylic acid unit (A4) represented by Formula (A4), and a dicarboxylic acid unit (A5) represented by Formula (A5).

(((7)))

The electrophotographic photoreceptor according to (((5))) or (((6))), wherein the diol unit (B) represented by Formula (B) includes at least one selected from the group consisting of a diol unit (B1) represented by Formula (B1), a diol unit (B2) represented by Formula (B2), a diol unit (B3) represented by Formula (B3), a diol unit (B4) represented by Formula (B4), a diol unit (B5) represented by Formula (B5), a diol unit (B6) represented by Formula (B6), a diol unit (B7) represented by Formula (B7), and a diol unit (B8) represented by Formula (B8).

(((8)))

The electrophotographic photoreceptor according to any one of (((1))) to (((3))), wherein the binder resin includes a polymer or a crosslinked body of a reactive group-containing charge transport material having, within an identical molecule, a reactive group and a charge-transporting skeleton.

(((9)))

The electrophotographic photoreceptor according to any one of (((1))) to (((8))), wherein the electrophotographic photoreceptor includes, on the conductive substrate, an undercoat layer, and a charge generation layer and a charge transport layer as the photosensitive layer in this order, and the outermost surface layer is the charge transport layer.

(((10)))

The electrophotographic photoreceptor according to any one of (((1))) to (((8))), wherein the electrophotographic photoreceptor includes, on the conductive substrate, an undercoat layer and a single layer-type photosensitive layer as the photosensitive layer, in this order, and the outermost surface layer is the single layer-type photosensitive layer.

(((11)))

The electrophotographic photoreceptor according to any one of (((1))) to (((8))), wherein the electrophotographic photoreceptor includes, on the conductive substrate, an undercoat layer, a charge generation layer and a charge transport layer as the photosensitive layer, and a protective layer in this order, and the outermost surface layer is the protective layer.

(((12)))

A process cartridge comprising: the electrophotographic photoreceptor according to any one of (((1))) to (((11))), wherein the process cartridge is attachable to and detachable from an image forming apparatus.

(((13)))

An image forming apparatus comprising: the electrophotographic photoreceptor according to any one of (((1))) to (((11)));
a charging device that charges a surface of the electrophotographic photoreceptor;
an electrostatic latent image forming device that forms an electrostatic latent image on the charged surface of the electrophotographic photoreceptor;
a developing device that develops the electrostatic latent image formed on the surface of the electrophotographic photoreceptor with a developer containing a toner to form a toner image; and
a transfer device that transfers the toner image to a surface of a recording medium.
   (((14)))

A functional layer comprising:
a binder resin; and
silicone rubber particles in which primary particles have a volume-average particle diameter of 0.01 μm or more and less than 3 μm.
   (((15)))

The functional layer according to (((14))), further comprising: a charge transport material.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrophotographic photoreceptor comprising:
a conductive substrate; and
a photosensitive layer disposed on the conductive substrate,
wherein an outermost surface layer contains a binder resin and silicone rubber particles in which primary particles have a volume-average particle diameter of 0.01 μm or more and less than 3 μm.

2. The electrophotographic photoreceptor according to claim 1, wherein the outermost surface layer contains aggregated particles of the silicone rubber particles.

3. The electrophotographic photoreceptor according to claim 1, wherein a content of the silicone rubber particles is 0.5% by mass or more and 25% by mass or less with respect to the outermost surface layer.

4. The electrophotographic photoreceptor according to claim 1, wherein the outermost surface layer contains, as the binder resin, at least one of a polyarylate resin or a polycarbonate resin.

5. The electrophotographic photoreceptor according to claim 1, wherein the outermost surface layer contains, as the binder resin, a polyarylate resin having a dicarboxylic acid unit (A) represented by Formula (A) and a diol unit (B) represented by Formula (B), 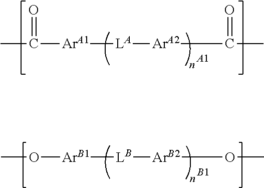
in Formula (A), Ar^{A1} and Ar^{A2} are each independently an aromatic ring that may have a substituent, L^{A} is a single bond or a divalent linking group, and n^{A1} is 0, 1, or 2,
in Formula (B), Ar^{B1} and Ar^{B2} are each independently an aromatic ring that may have a substituent, L^{B} is a single bond, an oxygen atom, a sulfur atom, or —C(Rb¹)(Rb²)—, and n^{B1} is 0, 1, or 2, where Rb¹ and Rb² are each independently a hydrogen atom, an alkyl group having 1 or more and 20 or less carbon atoms, an aryl group having 6 or more and 12 or less carbon atoms, or an aralkyl group having 7 or more and 20 or less carbon atoms, and Rb¹ and Rb² may be bonded to each other to form a cyclic alkyl group.

6. The electrophotographic photoreceptor according to claim 5, wherein the dicarboxylic acid unit (A) represented by Formula (A) includes at least one selected from the group consisting of a dicarboxylic acid unit (A1) represented by Formula (A1), a dicarboxylic acid unit (A2) represented by Formula (A2), a dicarboxylic acid unit (A3) represented by Formula (A3), a dicarboxylic acid unit (A4) represented by Formula (A4), and a dicarboxylic acid unit (A5) represented by Formula (A5), 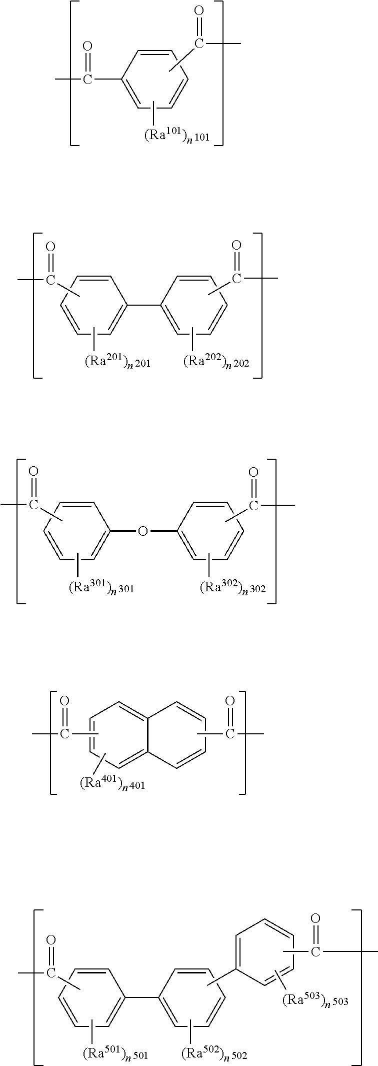
in Formula (A1), n¹⁰¹ is an integer of 0 or more and 4 or less, and n¹⁰¹ pieces of Ra¹⁰¹'s are each independently an alkyl group having 1 or more and 10 or less carbon atoms, an aryl group having 6 or more and 12 or less carbon atoms, or an alkoxy group having 1 or more and 6 or less carbon atoms,
in Formula (A2), n²⁰¹ and n²⁰² are each independently an integer of 0 or more and 4 or less, and n²⁰¹ pieces of Ra²⁰¹'s and n²⁰² pieces of Ra²⁰²'s are each independently an alkyl group having 1 or more and 10 or less carbon atoms, an aryl group having 6 or more and 12 or less carbon atoms, or an alkoxy group having 1 or more and 6 or less carbon atoms,
in Formula (A3), n³⁰¹ and n³⁰² are each independently an integer of 0 or greater and 4 or less, and n³⁰¹ pieces of Ra³⁰¹'s and n³⁰² pieces of Ra³⁰²'s are each independently an alkyl group having 1 or more and 10 or less carbon atoms, an aryl group having 6 or more and 12 or less carbon atoms, or an alkoxy group having 1 or more and 6 or less carbon atoms,
in Formula (A4), n⁴⁰¹ is an integer of 0 or greater and 6 or less, and n⁴⁰¹ pieces of Ra⁴⁰¹'s are each independently an alkyl group having 1 or more and 10 or less carbon atoms, an aryl group having 6 or more and 12 or less carbon atoms, or an alkoxy group having 1 or more and 6 or less carbon atoms,
in Formula (A5), n⁵⁰¹, n⁵⁰², and n⁵⁰³ are each independently an integer of 0 or greater and 4 or less, and n⁵⁰¹ pieces of Ra⁵⁰¹'s, n⁵⁰² pieces of Ra⁵⁰²'s, and n⁵⁰³ pieces of Ra⁵⁰³'s are each independently an alkyl group having 1 or more and 10 or less carbon atoms, an aryl group having 6 or more and 12 or less carbon atoms, or an alkoxy group having 1 or more and 6 or less carbon atoms.

7. The electrophotographic photoreceptor according to claim 5, wherein the diol unit (B) represented by Formula (B) includes at least one selected from the group consisting of a diol unit (B1) represented by Formula (B1), a diol unit (B2) represented by Formula (B2), a diol unit (B3) represented by Formula (B3), a diol unit (B4) represented by Formula (B4), a diol unit (B5) represented by Formula (B5), a diol unit (B6) represented by Formula (B6), a diol unit (B7) represented by Formula (B7), and a diol unit (B8) represented by Formula (B8), 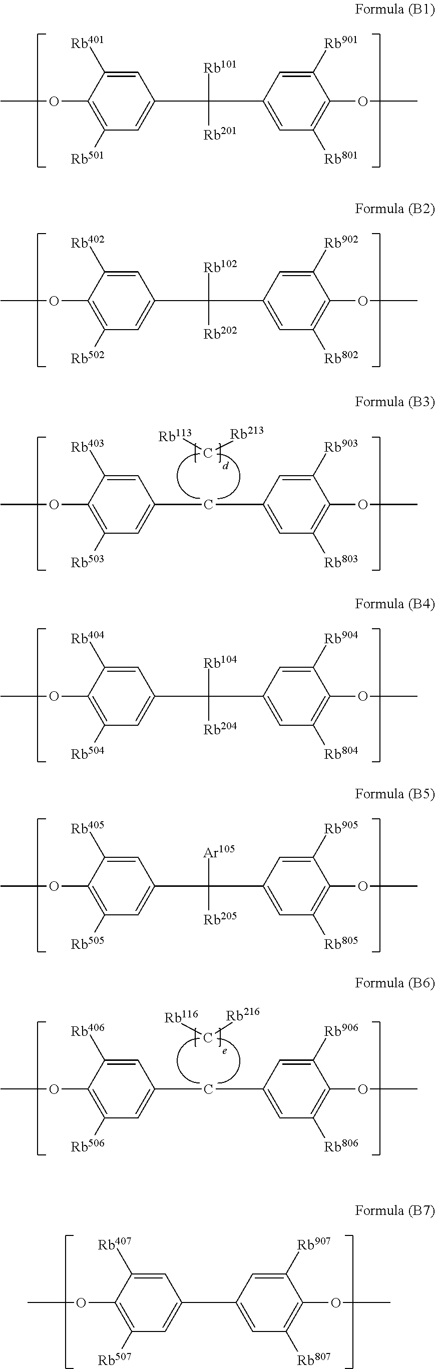 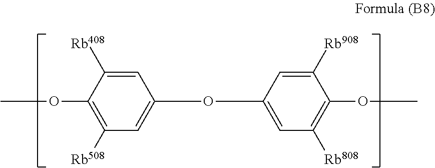
in Formula (B1), Rb¹⁰¹ is a branched alkyl group having 4 or more and 20 or less carbon atoms, Rb²⁰¹ is a hydrogen atom or an alkyl group having 1 or more and 3 or less carbon atoms, and Rb⁴⁰¹, Rb⁵⁰¹, Rb⁸⁰¹, and Rb⁹⁰¹ are each independently a hydrogen atom, an alkyl group having 1 or more and 4 or less carbon atoms, an alkoxy group having 1 or more and 6 or less carbon atoms, or a halogen atom,
in Formula (B2), Rb¹⁰² is a linear alkyl group having 4 or more and 20 or less carbon atoms, Rb²⁰² is a hydrogen atom or an alkyl group having 1 or more and 3 or less carbon atoms, and Rb⁴⁰², Rb⁵⁰², Rb⁸⁰², and Rb⁹⁰² are each independently a hydrogen atom, an alkyl group having 1 or more and 4 or less carbon atoms, an alkoxy group having 1 or more and 6 or less carbon atoms, or a halogen atom,
in Formula (B3), Rb¹¹³ and Rb²¹³ are each independently a hydrogen atom, a linear alkyl group having 1 or more and 3 or less carbon atoms, an alkoxy group having 1 or more and 4 or less carbon atoms, or a halogen atom, d is an integer of 7 or greater and 15 or less, and Rb⁴⁰³, Rb⁵⁰³, Rb⁸⁰³, and Rb⁹⁰³ are each independently a hydrogen atom, an alkyl group having 1 or more and 4 or less carbon atoms, an alkoxy group having 1 or more and 6 or less carbon atoms, or a halogen atom,
in Formula (B4), Rb¹⁰⁴ and Rb²⁰⁴ are each independently a hydrogen atom or an alkyl group having 1 or more and 3 or less carbon atoms, and Rb⁴⁰⁴, Rb⁵⁰⁴, Rb⁸⁰⁴, and Rb⁹⁰⁴ are each independently a hydrogen atom, an alkyl group having 1 or more and 4 or less carbon atoms, an alkoxy group having 1 or more and 6 or less carbon atoms, or a halogen atom,
in Formula (B5), Ar¹⁰⁵ is an aryl group having 6 or more and 12 or less carbon atoms or an aralkyl group having 7 or more and 20 or less carbon atoms, Rb²⁰⁵ is a hydrogen atom or an alkyl group having 1 or more and 3 or less carbon atoms, and Rb⁴⁰⁵, Rb⁵⁰⁵, Rb⁸⁰⁵, and Rb⁹⁰⁵ are each independently a hydrogen atom, an alkyl group having 1 or more and 4 or less carbon atoms, an alkoxy group having 1 or more and 6 or less carbon atoms, or a halogen atom,
in Formula (B6), Rb¹¹⁶ and Rb²¹⁶ are each independently a hydrogen atom, a linear alkyl group having 1 or more and 3 or less carbon atoms, an alkoxy group having 1 or more and 4 or less carbon atoms, or a halogen atom, e is an integer of 4 or greater and 6 or less, and Rb⁴⁰⁶, Rb⁵⁰⁶, Rb⁸⁰⁶, and Rb⁹⁰⁶ are each independently a hydrogen atom, an alkyl group having 1 or more and 4 or less carbon atoms, an alkoxy group having 1 or more and 6 or less carbon atoms, or a halogen atom,
in Formula (B7), Rb⁴⁰⁷, Rb⁵⁰⁷, Rb⁸⁰⁷, and Rb⁹⁰⁷ are each independently a hydrogen atom, an alkyl group having 1 or more and 4 or less carbon atoms, an alkoxy group having 1 or more and 6 or less carbon atoms, or a halogen atom,
in Formula (B8), Rb⁴⁰⁸, Rb⁵⁰⁸, Rb⁸⁰⁸, and Rb⁹⁰⁸ are each independently a hydrogen atom, an alkyl group having 1 or more and 4 or less carbon atoms, an alkoxy group having 1 or more and 6 or less carbon atoms, or a halogen atom.

8. The electrophotographic photoreceptor according to claim 1, wherein the binder resin includes a polymer or a crosslinked body of a reactive group-containing charge transport material having, within an identical molecule, a reactive group and a charge-transporting skeleton.

9. The electrophotographic photoreceptor according to claim 1, wherein the electrophotographic photoreceptor includes, on the conductive substrate, an undercoat layer, and a charge generation layer and a charge transport layer as the photosensitive layer in this order, and the outermost surface layer is the charge transport layer.

10. The electrophotographic photoreceptor according to claim 1, wherein the electrophotographic photoreceptor includes, on the conductive substrate, an undercoat layer and a single layer-type photosensitive layer as the photosensitive layer, in this order, and the outermost surface layer is the single layer-type photosensitive layer.

11. The electrophotographic photoreceptor according to claim 1, wherein the electrophotographic photoreceptor includes, on the conductive substrate, an undercoat layer, a charge generation layer and a charge transport layer as the photosensitive layer, and a protective layer in this order, and the outermost surface layer is the protective layer.

12. A process cartridge comprising: the electrophotographic photoreceptor according to claim 1, wherein the process cartridge is attachable to and detachable from an image forming apparatus.

13. A process cartridge comprising: the electrophotographic photoreceptor according to claim 2, wherein the process cartridge is attachable to and detachable from an image forming apparatus.

14. A process cartridge comprising: the electrophotographic photoreceptor according to claim 3, wherein the process cartridge is attachable to and detachable from an image forming apparatus.

15. A process cartridge comprising: the electrophotographic photoreceptor according to claim 4, wherein the process cartridge is attachable to and detachable from an image forming apparatus.

16. A process cartridge comprising: the electrophotographic photoreceptor according to claim 5, wherein the process cartridge is attachable to and detachable from an image forming apparatus.

17. A process cartridge comprising: the electrophotographic photoreceptor according to claim 6, wherein the process cartridge is attachable to and detachable from an image forming apparatus.

18. An image forming apparatus comprising:
the electrophotographic photoreceptor according to claim 1;
a charging device that charges a surface of the electrophotographic photoreceptor;
an electrostatic latent image forming device that forms an electrostatic latent image on the charged surface of the electrophotographic photoreceptor;
a developing device that develops the electrostatic latent image formed on the surface of the electrophotographic photoreceptor with a developer containing a toner to form a toner image; and
a transfer device that transfers the toner image to a surface of a recording medium.

19. A functional layer comprising:
a binder resin; and
silicone rubber particles in which primary particles have a volume-average particle diameter of 0.01 μm or more and less than 3 μm.

20. The functional layer according to claim 19, further comprising:
a charge transport material.
